(19) United States
(12) Patent Application Publication
(10) Pub. No.: US 2013/0311590 A1
(43) Pub. Date: Nov. 21, 2013

(54) METHOD AND SYSTEM FOR MAINTAINING, INDIVIDUALIZING AND UPDATING CONTACT INFORMATION ACROSS VARIOUS PLATFORMS

(71) Applicant: Frédéric Chagnon, New York, NY (US)

(72) Inventor: Frédéric Chagnon, New York, NY (US)

(73) Assignee: FADALABS, INC., New York, NY (US)

(21) Appl. No.: 13/983,495

(22) PCT Filed: Sep. 7, 2012
(86) PCT No.: PCT/US12/54194

§ 371 Date: Aug. 2, 2013

Related U.S. Application Data
(60) Provisional application No. 61/532,780, filed on Sep. 9, 2011.

(51) Int. Cl. H04L 12/58

(52) U.S. Cl. CPC H04L 51/046
USPC 709/206

(57) ABSTRACT

A method and system for managing contact information for a user is disclosed herein. In one embodiment, a method of managing contact information for a user includes creating one or more personas for a user, as well as one or more contact handles that each includes an identifying name, one or more communication protocols, and a value. The method further includes creating, for each of the personas of the user, one or more availability statuses that each includes a persona-specific listing of selected contact handles and communication methods that may be used to reach the user. The method further includes determining a current availability status among the one or more availability statuses, and communicating to one or more other users the persona-specific listing of contact handles and communication methods associated with the current availability status for each persona of the user that the other users have been granted access to.

### BACKGROUND

Contacting a person is no longer as simple a process as it used to be. As Frank Bruni put it in the New York Times (Aug. 31, 2011) “[ . . . ] the maddening truth is that we've become so accessible we're often inaccessible, the process of getting to any of us more tortured and tortuous than ever. [ . . . ] There are up to a dozen possible routes, and the direct one versus the scenic one versus the loop-de-loop versus the dead end changes from person to person. If you're not dealing with your closest business associates or friends, whose territory and tics you've presumably learned, you're lost”, or as Elizabeth Bernstein put it in the Wall Street Journal (Jul. 5, 2012) “It's a growing, yet unspoken problem in many relationships these days: We've become communicatively incompatible. There are too many ways to converse, each of us has a favored method (mine is email), and no one wants to compromise.” Indeed, with the advent of mobile devices and the increased variation in the numbers of ways people relate to one-another, a more immediate and often interactive response is expected.

How we go about accomplishing this has also become more difficult. Address books, whether paper-based or electronic, are never up-to-date. They often contain multiple “contact handles” for the same person: phone numbers (home, mobile, work, etc.), email addresses (work, Gmail, Yahoo, etc.), chat handles (Gtalk, AIM, BBM, Skype, etc.), mailing addresses, (micro)blogs and homepages (twitter, tumblr, etc.) All this information is in a constant state of flux, and thus often unmanageable. Moreover, the burden of managing this information has historically been on the person seeking to contact the individual, not on the person whose contact information is constantly changing. Arguably, an individual is best suited to manage their own contact information.

Further complications are introduced by personal preferences and by situational context, whether because people prefer to be contacted via different means at different times (e.g., voice call when they are driving, text message or mail when they are in a meeting, etc.), or because many contact handles are irrelevant at the instant a contact event is initiated (e.g., calling someone at home when they're at work.)

Even further complications are introduced by personal context. Indeed, people typically incarnate different “personae” depending on who are they are interacting with (e.g., “work” persona, “family” persona, “school” persona, “friends” persona, etc.) and each persona has its own social circle. It typically follows that communication preferences are circle-specific. For example, we may prefer to have our clients call us at the office while we may prefer that our friends text message us on our personal mobile telephones. Currently, there is no way to manage the way that different people contact us. There is thus a need for a means to “pull” the way people in our different groups reach us, to keep this information always up-to-date, and to seamlessly communicate these differentiated preferences to our contact networks.

### SUMMARY OF THE INVENTION

The present invention addresses the difficulties described above by providing a system and method for managing contact information for a user that lets a user create and maintain one or more preset lists of contact handles and communication methods that can be used to reach the user. These lists can be expressed as availability statuses, and can contain as many or as few contact handles for each contact method (i.e. one for voice calls, two for email, none for chat, one for text message, etc.) as the user desires. Such a system and method allows a user to actively update his or her preferences for being contacted, and can communicate these preferences to one or more other users of the system associated with the user.

In one aspect, a method of managing contact information for a user is provided that includes creating with a digital data processor one or more personas in response to receiving personal information from the user. The method also includes creating with a digital data processor one or more contact handles associated with the user, wherein each contact handle includes an identifying name, one or more communication protocols, and a value. The method further includes creating with a digital data processor one or more availability statuses, wherein each availability status includes, for each of the one or more personas of the user, a persona-specific listing of selected contact handles and communication methods that may be used to reach the user, wherein each communication method is associated with a communication protocol of a contact handle (e.g., a contact handle for a mobile phone may include protocols for voice and Short Message Service, or SMS, communication, and corresponding communication methods may include making a telephone call and sending a text message). The method also includes storing the one or more personas, the one or more contact handles, and the one or more availability statuses in a data store accessible to the digital data processor. Still further, the method includes determining a current availability status from the one or more availability statuses of the user, and communicating to one or more other users the persona-specific listing of selected contact handles and communication methods associated with the current availability status for each of the one or more personas of the user that the one or more other users have been granted access to.

Such a method can provide a number of advantages for users in managing contact information that is communicated to various other users. For example, in some embodiments a user can create multiple personas that correspond to the user's various personae (e.g., “family” persona, “work” persona, “college friends” persona). These personas may contain personal information from the user that is specific to a given persona including, but not limited to, avatar picture, name, nickname, phonetic name, job title, department, company, recorded greeting, quote, etc.

Using the methods and systems disclosed herein, users can set persona-specific listings of contact handles and communication methods for each of their different personas (e.g., I wish to be called on my office phone and then emailed on my work email address for my “work” persona; and I to be texted on my iPhone and called on Skype for my “friend” persona).

The methods and systems disclosed herein can include a number of additional features or modifications, each of which is considered within the scope of the present invention. For example, in some embodiments, the selected contact handles and communication methods in the persona-specific listing associated with an availability status can be ranked by the user. Such a ranking can communicate the user's preference for how they wish to be contacted. For example, a user may decide that his/her first choice is to be called on his/her personal mobile phone, his/her second choice is to be texted on Skype, and his/her last choice is to be emailed at his/her work email address.

In some embodiments, the user's current availability status can be communicated automatically to the one or more other users such that contact preferences for the user are constantly kept up to date.

In certain embodiments, a user's current availability status can be determined based on a selection received from the user. For example, the persona-specific listings of contact handles and communication methods associated with an availability status can be saved so that a user can manually select his/her current availability status from a list of presets. For example, a user may create an “Available” preset (first choice to be called on iPhone, second choice to be called at work) and a “Busy” preset (first choice to be texted on iPhone, second choice to be emailed at work). The user would then be able to quickly toggle between these different presets depending on his/her current situational context and/or personal preference.

In other embodiments, however, the user's current availability status can be determined based on a received physical or temporal location of the user. In such an embodiment, the user's current availability status can be automatically determined and updated by the system. For example, preset availabilities may be geo-fenced and associated with a specific location, and global positioning data may be used to determine that an individual is at a predetermined location (e.g., work, home) and the individual's current availability status may be toggled appropriately and automatically updated.

In still other embodiments, the user's current availability status can be determined based on a state of a device associated with the user. For example, current availability status can be changed from an “Available” status to a “Busy” status when a user switches their mobile device to a “silent” operating profile or when a user powers off their mobile device.

Contact handles and communication methods as utilized in the methods and systems described herein can include any existing or future method for communicating between two users. For example, in some embodiments, the one or more contact handles can include, without limitation, a landline phone number, a mobile phone number, an email address, a chat address, a social networking page, a web address, a postal address, or other physical or electronic address. Each contact handle created by a user can include, for example, an identifying name (e.g., “cell phone”), one or more communication protocol capabilities (e.g., “voice,” “SMS,” etc.), and a value (e.g., “555-1212”). Further, in some embodiments, the communication methods can include, without limitation, making a voice call, sending an email, sending a text message, posting to a website, launching a chat session, posting to a microblog, or sending a message through a proprietary or 3^{rd} party social network. In some embodiments, each communication method can correspond to a communication protocol associated with a contact handle (e.g., “sending a text message” can correspond to an “SMS” communication protocol).

The systems and methods disclosed herein can be implemented in any combination of hardware or software. In some embodiments, the system can include a central storage system and a plurality of remote devices. Furthermore, in some embodiments, communicating to the one or more other users the persona-specific listing of selected contact handles and communication methods associated with the current availability status of the user can include communicating between the data store and a plurality of remote devices. The remove devices can include any number of currently known or future remote devices, including personal computers and mobile computing devices such as tablet computers, PDA's, cell phones, and smart phones.

By way of example, in some embodiments, the communication method (e.g., sending a text or making a voice call) can be performed by accessing a software application resident on a remote device. That is, if a first user's first preference for the current availability status is to be texted at their mobile phone number, a second user on a remote device can reach the first user via the preferred communication method by accessing the texting application on their remote device. In the methods and systems described herein, a remote device can access the data store, determine a preferred contact handle and communication method for a user, and proceed to contact the user via the preferred contact handle and communication method.

In some embodiments, if a user is unavailable, other users can request a return call or contact rather than leaving a voicemail or other message. For example, in some embodiments, the methods described herein can include receiving a request for contact from one or more users and notifying a user of the request for contact. For example, if a first user of a system according to the invention is unavailable, a second user can elect to leave a “contact-back” request with the first user. The system can receive such a request and notify the first user of the request to contact the second user. The first user can then contact the second user at his/her convenience.

In another aspect, a system for managing contact information for a plurality of users is provided that includes a first digital data processor coupled to a data store and configured to store for each of the plurality of users one or more personas created by the user, wherein each persona includes personal information provided by the user. The first digital data processor is further configured to store one or more contact handles in association with the user, wherein each contact handle includes an identifying name, one or more communication protocols, and a value. The first digital data processor is also configured to store one or more availability statuses created by the user, wherein each availability status includes, for each of the one or more personas of the user, a persona-specific listing of selected contact handles and communication methods that may be used to reach the user, wherein each communication method is associated with a communication protocol of a contact handle. Still further, the first digital data processor is also configured to store one or more contacts associated with the user, each contact being another user on the system for which the user has granted access to one or more personas of the user. The system also includes a remote device that includes a second digital data processor that is configured to generate a look-up request for transmission to the first digital data processor in response to input from a first user and display to the first user results received from the first digital data processor in response to said request. The first digital data processor is further configured to receive the look-up request from the remote device, access the data store to obtain the persona-specific listing of selected contact handles and communication methods associated with a current availability status of a second user, the listing being specific to a relationship between the first user and the second user that matches the look-up request, and transmit the listing to the second digital data processor.

In some embodiments, the second digital data processor can be configured to compare the communication methods received from first digital data processor with communication methods stored in association with the first user and prioritize the communication methods common to both the first and the second user. In such an embodiment, the stored communication preferences for both users can be incorporated into determining which communication method is presented as a first option, second option, etc. Furthermore, in certain embodiments, different weights can be assigned to the user being contacted versus the user making contact (e.g., more weight can be given to the preferences of the user being contacted, or vice versa).

In other embodiments, the second digital data processor can be further configured to initiate contact between the first user and the second user via the contact handles and communication methods of the second user's persona-specific listing.

In still other embodiments, the second digital data processor can be further configured to transmit to the first digital data processor a request for contact from the second user. In other words, the system can be configured to allow a user to set a “contact-back” flag on any specific user instead of messaging or leaving a voice mail, thereby “pulling” a request for contact-back. For example, a first user consulting a second user's persona can be presented with options to call the second user's iPhone, text message that same iPhone, or email the second user's Gmail account (all of these options having been set by the second user). The system can automatically append a “contact-back” option to the end of the second user's list of contact information. The first user can thus have the choice to use a method of contact as set by the second user or to press the “contact-back” button, in which case the second user can be notified that the first user wishes that s/he contact them back.

In some embodiments, the system can be implemented as a social networking system. In one embodiment, the social networking system can be a so-called “closed” system wherein access to a user's information is only available to members of the network who are connected to the user and access is only available through the network. In a further embodiment, a user can give access to one or more of his/her personas to one or more other users that s/he is connected to. In such an embodiment, the one or more other users can be presented with different prioritized lists of contact methods for each of the personas s/he has been granted access to. For example, a user may wish to present his/her work persona to his/her work colleagues, and give these work colleagues specific instructions on how s/he wishes to be contacted in a professional context.

In other embodiments, the second digital data processor can be further configured to create sub-lists of the one or more contacts associated with the user based on the current availability statuses of the one or more contacts and the communication methods associated therewith. In other embodiments, the first digital data processor can be configured to create such sub-lists and transmit them to the second digital data processor. In other words, the system can be configured to create sub-lists of a user's contacts automatically based on specific criteria. For example, a user driving on his/her commute to work may wish to consult which of his/her contacts are available to talk. In such a case, the system can create a sub-list of contacts based on the criteria that these contacts have set a voice call method of contact as their first choice. In one embodiment, such sub-lists can be further segmented by persona (e.g., show me which one of the contacts associated with my “clients” persona is available to talk).

In another aspect, a method of managing the manner in which an individual may be contacted is provided that includes (a) creating a system comprising a database of users; (b) having each individual user in said database create one or more personas, each persona comprising information specific to that persona (e.g., name, nickname, job title, company); (c) having each individual in said database create one or more contact handles, each contact handle comprising a name (e.g. “iPhone”), a protocol of contact (e.g., “mailto”, “sms”, “tel”) and a corresponding value (e.g., +1 (212) 555-5555); (d) having each individual in said database create one or more availability statuses that describe the way the individual wishes to be contacted for each of his/her personas; (e) storing said personas, contact information and availability statuses in a database, the database being remotely accessible from a computing or mobile device; and (e) communicating the individual's current availability statuses to other users of the system that have been previously associated with the individual based on the personas that these users have been granted access to.

In some embodiments, a user can be associated with a prioritized list of contact handles that relate to one or more of the user's personas. Each contact handle can be associated with a specific way in which the user may be contacted, including but not limited to a landline phone number, mobile phone number, email address, chat address, social networking page, web address, postal address, or other physical or electronic address. In one embodiment, a second user can access the contact handle associated with the user and proceed to appropriately use the particular information associated with said contact handle to attempt to contact the user. For example, the second user may make a voice call to a mobile number or a landline, send an email, sending a text message, post to a website or launch a chat session, depending on what contact information is associated with the user's persona. In one embodiment, the user's contact handles can be presented in a prioritized list, wherein the prioritization (e.g., try me “here” first) is set by the user. In an alternative embodiment, the contact handle prioritization is set automatically by the system of the invention.

In still another embodiment, a user's contact information can be presented to a second user in a prioritized manner based on the user's persona. The prioritized list of contact information may vary depending on both the user's persona and/or the specific user. In one embodiment, various users would see different contact handles (and thereby have access to different contact information) with possibly different prioritizations based on the user's persona, which defines the relationship between the second user and the user (e.g., work colleague, family member, friend, etc.). In a further aspect of the invention, a second user may or may not have access to the user's specific contact handle and information. By way of example, a second user that may be associated with the user's “work” persona may have access to the user's mobile phone information as well as the user's office landline number. However, a third user who is associated with the user's “home” persona may only have access to the user's mobile phone number.

In certain embodiments, a user can set an availability status that inactivates all his contact handles for a specific persona (and thereby signal to his contacts that he wishes to remain undisturbed). In such a case, when one of the user's contacts tries to contact him/her through the system, they can be presented with a “contact-back” button. Pressing the button can send a contact-back request to the user. The user can receive a notification of that request through the system. For example, when the user opens an application on their remote device and accesses the notifications interface, s/he can be presented with the contact-back request. S/he can then see that one of his/her contacts has requested to be contacted. If the user selects the notification, s/he can be brought to the specific contact's screen and can be offered the ability to contact them back utilizing that contact's preferred means of communication at that time. This “contact-back” feature can replace the typical voicemail message that simply asks to be contacted back.

As mentioned above, the system can be implemented in any combination of hardware or software. In some embodiments, the system can include a central storage system and a plurality of remote devices. The system can be implemented using any number of software applications resident on the aforementioned devices. In some embodiment, the system can include a software application on a remote device. In certain embodiments, a user can contact another user by accessing the software application resident on their remote device. In one embodiment, the remote device can contact a database resident in the central storage system, determine the preferred contact handle for the other user, and proceed to contact the other user through the system. In a further embodiment, the remote device can contact a database resident in the central storage system and determine the ordered list of preferred contact handles for the other user and present them on the remote device. The user using the remote device can then select which of the contact handles s/he wishes to use to contact the other user and the remote device can subsequently contact the other user through the system.

In some embodiments, the system can utilize the remote device's native capabilities to complete the communication (i.e., the native telephone capability on a smart phone is utilized to complete a phone call). In some embodiments, however, the system can utilize its own capabilities to complete the communication (i.e., use the system to initiate and complete contact-back requests). In a further embodiment, the system can utilize a 3^{rd} party application to complete the communication (i.e., use the Gmail application to write and send emails; use Google Voice to initiate telephone calls). In still a further embodiment, the user can set preferences that determine which application is utilized to complete each communication based on the communication protocol (e.g., utilize the native phone app for local calls, utilize Google Voice for long-distance calls, utilize the Sparrow app for emails, etc.)

In another aspect, a system for managing an individual's contact information is provided that includes a memory having stored on it a database for storing a plurality of users created and maintained by a plurality of users; each user having one or more personas, the personas having information representative of (i) a user's picture, (ii) that user's name, (iii) that user's personal information including, but not limited to, job information); each user having one or more contact handles, the contact handles having information representative of (i) the contact handle's name, (ii) the contact handle's protocol (e.g., “tel”, “sms”, “mailto”), and (iii) that contact handle's value; each user having a set of one or more availability statuses, each availability status being a set of ordered lists of contact handles for each of the user's personas; and each user having multiple contacts, each contact being another user on the system for which the user has granted access to one or more of his/her personas.

In some embodiments, the system can further include a computational device having a first computer program stored on memory associated with the computational device, the first computer program comprising (i) code for receiving a look-up request from a computing or mobile device, (ii) code for accessing the database and obtaining contact information for a first user that is specific to the relationship between that first user and a second user that matches the look-up request; and (iii) code for contacting the first user by the second user through the system; and a remote device having a second computer program stored on memory of the remote device, the second computer program comprising (i) code for generating a look-up request to the first computer program, (ii) code for displaying the results of the look-up requests, (iii) code for generating a communication request and transmitting said request to the computational device, (iv) code for creating and editing user accounts, user personas, contact handles, availability statuses, and (v) code to uploading these to the first computer program.

In other embodiments, the second computer program of the system can further include code for automatically selecting the optimal method of contact between two users (for example by utilizing the highest ranked common communication protocol). In certain embodiments, the computational device can initiate a contact between the second user and the first user based on both the first and second users' current availability statuses.

### BRIEF DESCRIPTION OF THE DRAWINGS AND FIGURES

FIG. 1 is a schematic diagram of exemplary computer and communications equipment that may be used to implement embodiments of the present invention;

FIG. 2 is a flow chart depicting certain steps in one or more methods of the present invention and/or the functionality of certain code segments of one or more computer programs of the present invention;

FIG. 3 is another flow chart depicting certain steps in one or more methods of the present invention and/or the functionality of certain code segments of one or more computer programs of the present invention;

FIG. 4 is another flow chart depicting certain steps in one or more methods of the present invention and/or the functionality of certain code segments of one or more computer programs of the present invention;

FIG. 5 is another flow chart depicting certain steps in one or more methods of the present invention and/or the functionality of certain code segments of one or more computer programs of the present invention.

FIG. 6 is another flow chart depicting certain steps in one or more methods of the present invention and/or the functionality of certain code segments of one or more computer programs of the present invention;

FIG. 7 is another flow chart depicting certain steps in one or more methods of the present invention and/or the functionality of certain code segments of one or more computer programs of the present invention;

FIG. 8 is another flow chart depicting certain steps in one or more methods of the present invention and/or the functionality of certain code segments of one or more computer programs of the present invention;

FIG. 9 is another flow chart depicting certain steps in one or more methods of the present invention and/or the functionality of certain code segments of one or more computer programs of the present invention;

FIG. 10 is another flow chart depicting certain steps in one or more methods of the present invention and/or the functionality of certain code segments of one or more computer programs of the present invention;

FIG. 11 is another flow chart depicting certain steps in one or more methods of the present invention and/or the functionality of certain code segments of one or more computer programs of the present invention;

FIG. 12 is another flow chart depicting certain steps in one or more methods of the present invention and/or the functionality of certain code segments of one or more computer programs of the present invention;

FIG. 13 is another flow chart depicting certain steps in one or more methods of the present invention and/or the functionality of certain code segments of one or more computer programs of the present invention;

FIG. 15 is another flow chart depicting certain steps in one or more methods of the present invention and/or the functionality of certain code segments of one or more computer programs of the present invention;

FIG. 16 is another flow chart depicting certain steps in one or more methods of the present invention and/or the functionality of certain code segments of one or more computer programs of the present invention;

FIG. 17 is another flow chart depicting certain steps in one or more methods of the present invention and/or the functionality of certain code segments of one or more computer programs of the present invention;

FIG. 18 is another flow chart depicting certain steps in one or more methods of the present invention and/or the functionality of certain code segments of one or more computer programs of the present invention;

FIG. 19 is another flow chart depicting certain steps in one or more methods of the present invention and/or the functionality of certain code segments of one or more computer programs of the present invention;

FIG. 20 is another flow chart depicting certain steps in one or more methods of the present invention and/or the functionality of certain code segments of one or more computer programs of the present invention;

FIG. 21 is another flow chart depicting certain steps in one or more methods of the present invention and/or the functionality of certain code segments of one or more computer programs of the present invention;

FIG. 22 is another flow chart depicting certain steps in one or more methods of the present invention and/or the functionality of certain code segments of one or more computer programs of the present invention; and

FIGS. 23-32 are exemplary screen shots that may be displayed by a computer, tablet computer or mobile communication device such as a cell phone or PDA.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

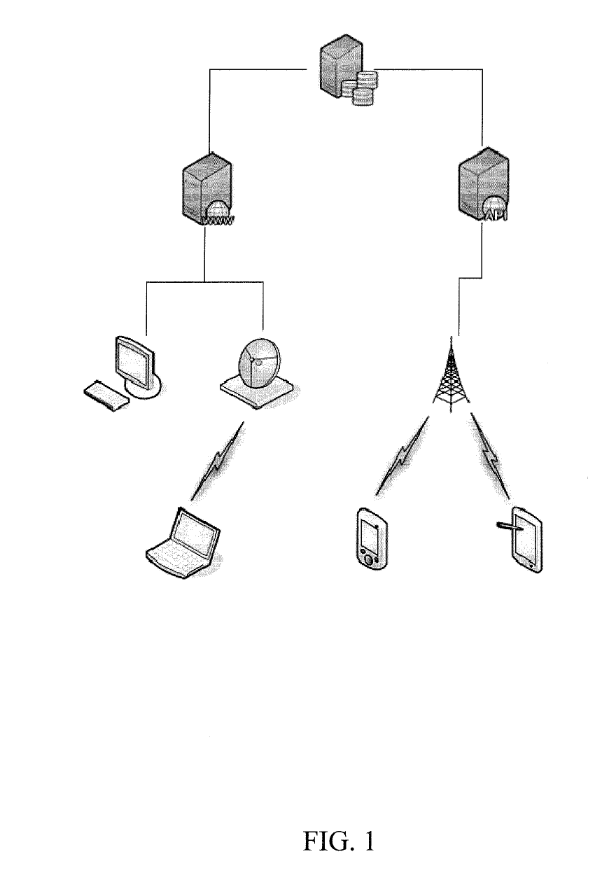

Embodiments of the present invention can be implemented in hardware, software, firmware, or a combination thereof. In one embodiment, the invention is implemented with computer and communications equipment broadly referred to in FIG. 1.

FIG. 1 shows a computer and communications equipment includes a database, one or more application servers, a plurality of remote devices, one or more computing devices, a wireless telecommunications network, and a communications network. The components of the computer and communication equipment illustrated and described herein are merely examples of equipment that may be used to implement embodiments of the present invention and may be replaced with other equipment without departing from the scope of the present invention.

In more detail, a database serves as a repository for user personas and programs used to implement certain aspects of the present invention as described in more detail below. The database may be centrally located or be distributed in nature (e.g. “cloud-based”). The database may include one or more servers running Windows; LAMP (Linux, Apache HTTP server, MySQL, and PHP/Perl/Python); Java; AJAX; NT; Novel Netware; Unix; or any other software system and includes or has access to computer memory and other hardware and software for receiving, storing, accessing, and transmitting user personas and related requests as described below. The database also includes conventional web hosting operating software, searching algorithms, an Internet connection, and is assigned a URL and corresponding domain name so that a website hosted thereon can be accessed via the Internet in a conventional manner.

Servers may be provided to distribute the data stored on the database, if necessary, so that the database is not over-burdened with user persona requests and other functions. Thus, the number of servers required depends on the number of users and personas stored in the database and the number of requests received by the database.

In some embodiments, many servers may be needed, and in other embodiments, only one or even no servers may be needed. The system may include one or more servers running Windows NT, Novel Netware, UNIX, Linux, or any other network operating system and includes or has access to computer memory and other hardware and software for receiving, storing, accessing, and transmitting user personas and related requests as described below. Each server may also include conventional web hosting operating software, searching algorithms, an Internet connection, and a URL and corresponding domain name so that a website hosted thereon can be accessed via the Internet in a conventional manner. The application servers may also host and support software and services of proprietary mobile application providers such as Google, Apple, and Blackberry.

The mobile devices may be any type of devices that can make and receive wireless communications such as phone calls, SMS texts, MMS messages, SMTP messages, etc. via a wireless telecommunication network. The mobile communication devices may include, for example, wireless phones, phone-enabled personal digital assistants, phone-enabled MP3 devices, phone-enabled handheld game players, or any other wireless communication device. In current embodiments of the invention, the mobile communication devices are “smart” phones such as those manufactured by Apple®, Blackberry®, Google®, HTC®, Samsung®, Nokia® or Motorola®. Each mobile communication device preferably includes or can access an Internet browser and a conventional Internet connection such as a wireless broadband connection, a modem, DSL converter, or ISDN converter so that it can access the database.

The computing devices may be any devices that can access the database. For example, the computing devices may be tablet, laptop, desktop or other personal computers such as those manufactured by Apple®, Research In Motion®, Samsung®, Dell®, or Toshiba®. As with the mobile communication devices, each computing device includes or can access an Internet browser and a conventional Internet connection such as a wireless broadband connection, a modem, DSL converter, or ISDN converter so that it can access the database via the communications network.

The communications network may be any communication network capable of supporting communications between the database and the various remote devices of the system. The system of the invention preferably operates over Internet but may be any other communications network such as a local area network, a wide area network, a wireless network, or an intranet, or through a combination of several networks.

The computer programs of the present invention are stored in or on computer-readable medium residing on or accessible by the database, and the mobile communication devices. One embodiment of the invention includes one or more computer programs that implement functions and features of the invention on the database and a client software application that may be loaded on some or all of the mobile devices for implementing functions and features of the invention on the mobile communication devices.

The computer programs preferably comprise ordered user personas of executable instructions for implementing logical functions in their respective devices. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

Any wireless communications may be supported by the present invention including, but not limited to, SMS text messages, multi-media message service (MMS) messages, SMTP messages, Skype, and e-mail.

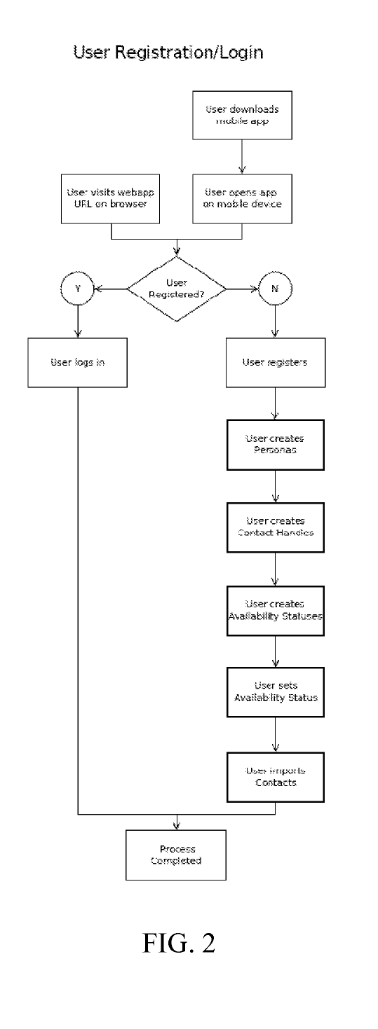

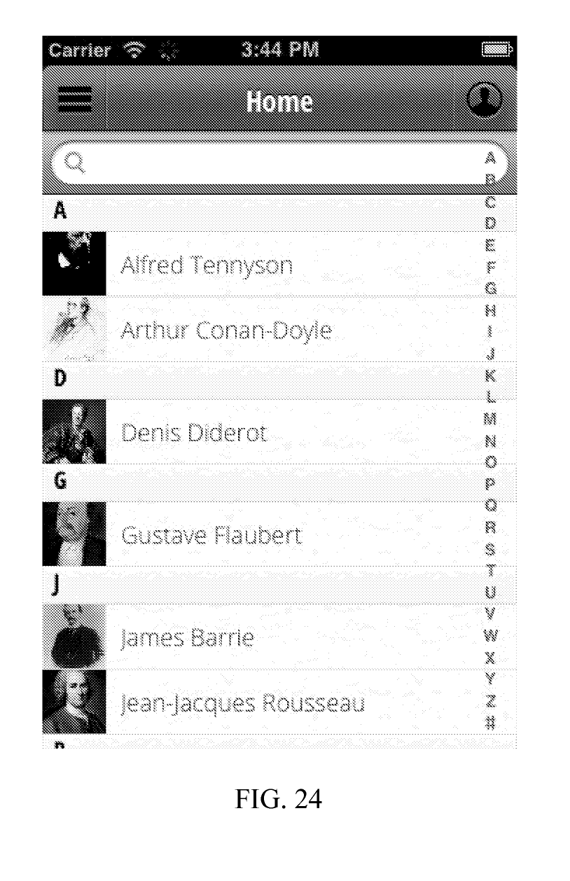

The flow charts of FIGS. 2-23 and the screen shots of FIGS. 24-29 show the functionality and operation of implementations of the invention in more detail. In this regard, some of the blocks of the flow charts and portions of the screen shots may represent exemplary steps in methods of the present invention and/or a module segment or portion of code of computer programs of the present invention. The module segments or code segments of the computer programs comprise one or more executable instructions for implementing the specified logical function or functions. In some alternative implementations, the functions noted in the various blocks may occur out of the order depicted in FIGS. 2-23. For example, two blocks shown in succession may in fact be executed substantially concurrently, or the blocks may sometimes be executed in the reverse order depending upon the functionality involved.

FIG. 2 depicts a typical procedure for user registration and login to the system of the invention. Typically a User downloads the application from a mobile store (iTunes Store, Google Play, etc.) to their mobile device, personal computer or other computing device. The user then opens the application. If the User is already registered with the service, s/he logs in where the User is brought to the main application interface. If the User isn't registered yet, s/he proceeds to register with the system. After the registration process is completed, the User is then able to setup his/her account (i.e., create or edit his/her Personas, create or edit his/her Contact Handles, create or edit his/her Availability Statuses, set his/her current Availability Status, Import his/her existing contact lists from external services).

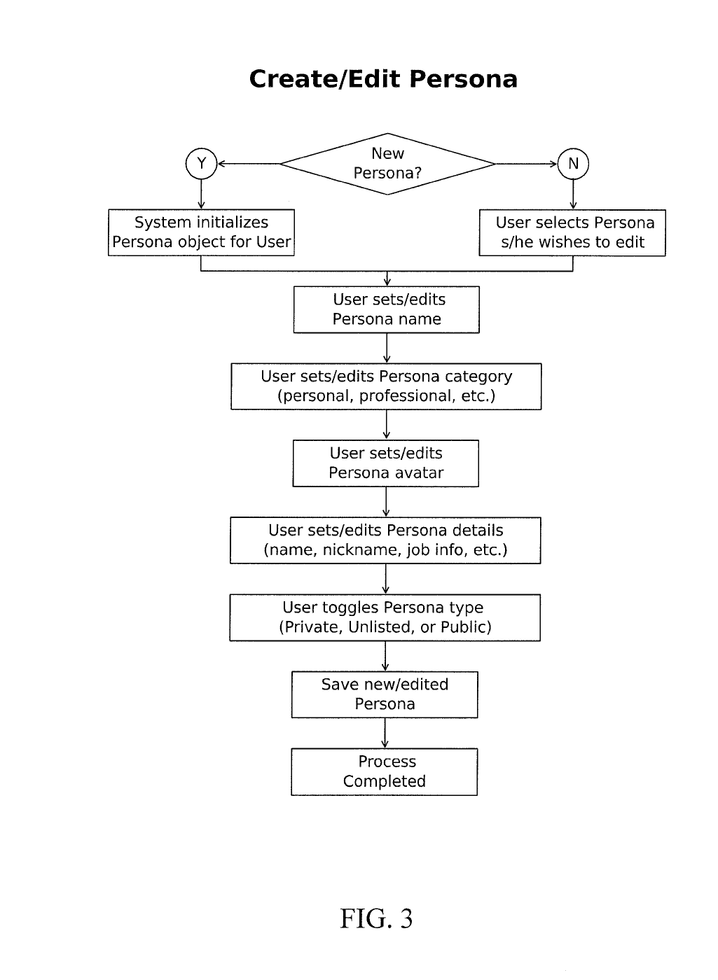

FIG. 3 depicts an exemplary procedure by which an individual may create and edit a Persona. If the User is creating a new Persona, the System initializes a new Persona object for that User. If the User is editing an existing Persona, the System fetches the Persona object. The User sets the Persona category (e.g., Professional or Personal). The User then names/renames the Persona (e.g., from “Work” to “Acme”). The User then sets/edits the information for the Persona (e.g., avatar picture, first name, last name, job information). The User then selects the type of Persona (i.e., Private, Unlisted or Public). The User then saves the new/edited Persona and the information on the local device and server are updated.

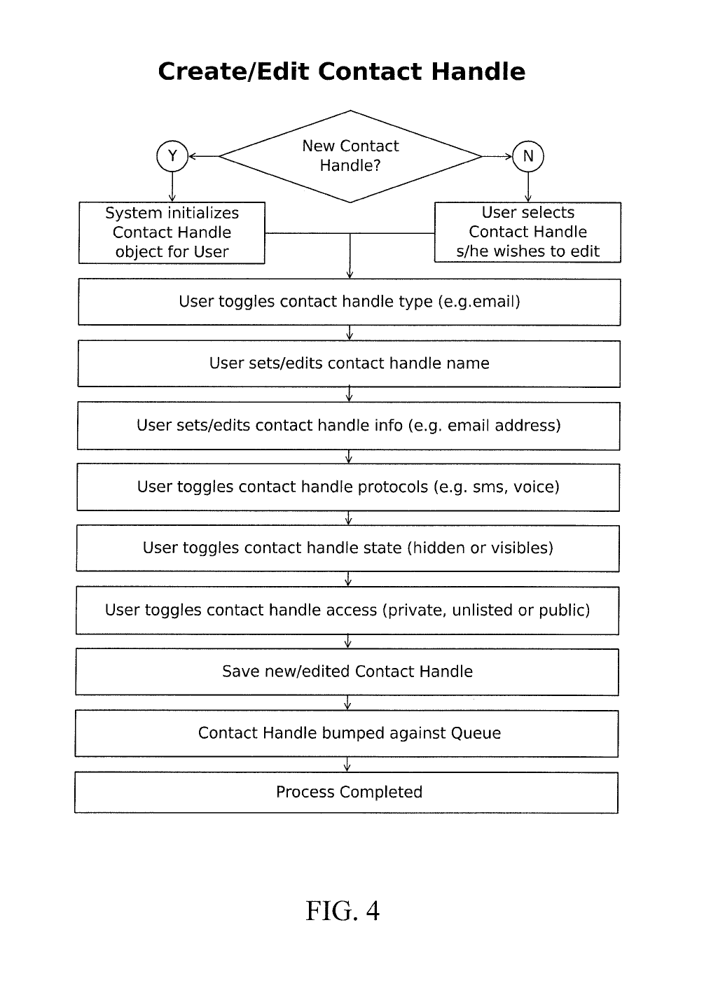

FIG. 4 depicts how an individual may create and edit a specific contact handle. If the User is creating a new contact handle, the System initializes a new contact handle object. The User then selects the contact handle type from a list (i.e. telephone, email, chat, Skype, mailing address, etc.). The User can also enter a custom type. The User then names the contact handle (e.g. “Work Phone”). The User then enters the value associated with that contact handle (i.e. +1 (212) 555-5555). The User then selects which protocols are enabled for the Contact Handle (e.g., for an iPhone type, the available protocols could include “Voice”, “sms”, “iMessage”, “Facetime”). The User then toggles the Contact Handle state (i.e., hidden or visible).

Alternatively, if the User is editing an existing contact handle, s/he selects the contact handle s/he wishes to edit and the System fetches that contact handle object. The User can edit the type, name, value, and enabled protocols for the Contact Handle.

Once the contact handle is created or edited, the User can then set the state of the contact handle (hidden to inactivate it, visible to activate it). The User can also set the accessibility of the contact handle (private to make it only viewable to people in his/her network, public to make it publicly viewable). The User then saves the contact handle. The new/edited Contact Handle is then bumped against the Queue (see Queue process).

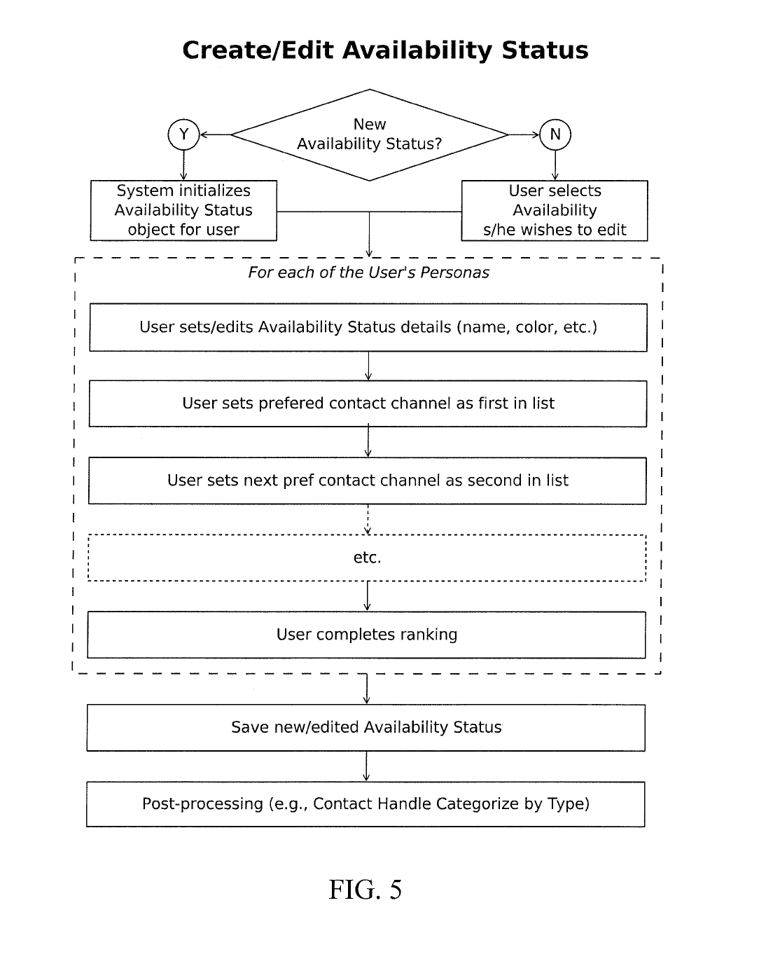

FIG. 5 depicts how an individual may create/edit an Availability Status (i.e., preferred communication means, or prioritized list of contact information). In other words, this process describes how the User can create/edit a status that tells his/her contacts how s/he wishes to be contacted. The User first edits/sets the name for this Availability Status, and also associated an image with this Availability Status (e.g., a colored box). If the User wishes to assign a single contact handle to a particular Persona, The User selects the contact handle s/he wishes to be contacted at and drags it into the active area (thereby giving it a rank of 1).

If the User wishes to give his contacts many options to contact him/her then the User selects his preferred contact handle and assigns it the rank of 1 by dragging it to the top of the active area. The User then selects his next preferred contact handle and assigns it a rank of 2, etc. The User then completes the ranking of contact handles for a Persona, and repeats the same process for all of his Personas. The System then goes through the “Contact Handle Categorization by Type” process for each Persona for this specific Availability Status.

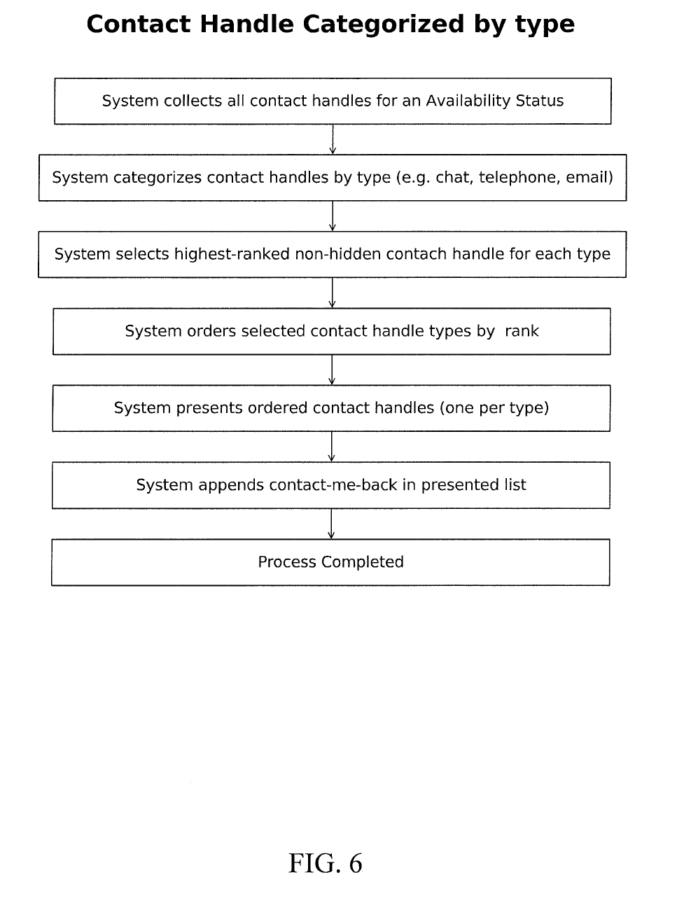

FIG. 6 depicts how the system may optionally automatically categorize and create a prioritized list of contact handles based on type of contact handle for a specific Availability Status. If an Availability Status has a single active Contact Handle for a Persona, the selection is straight-forward and the System sets a unique contact handle for that Persona for the specific Availability Status.

If the Availability Status has multiple active contact handles for a Persona, the System collects all the active contact handles and then categorizes the contact handles by protocol type (i.e. voice, email, sms, etc.). The system then picks the highest ranked contact handle for each protocol type and orders the selected contact handles by their original rank. The System optionally appends the contact-back option to the list of contact handles. Finally, the System presents the list of selected Contact Handles to the Persona's network when they select that specific Persona.

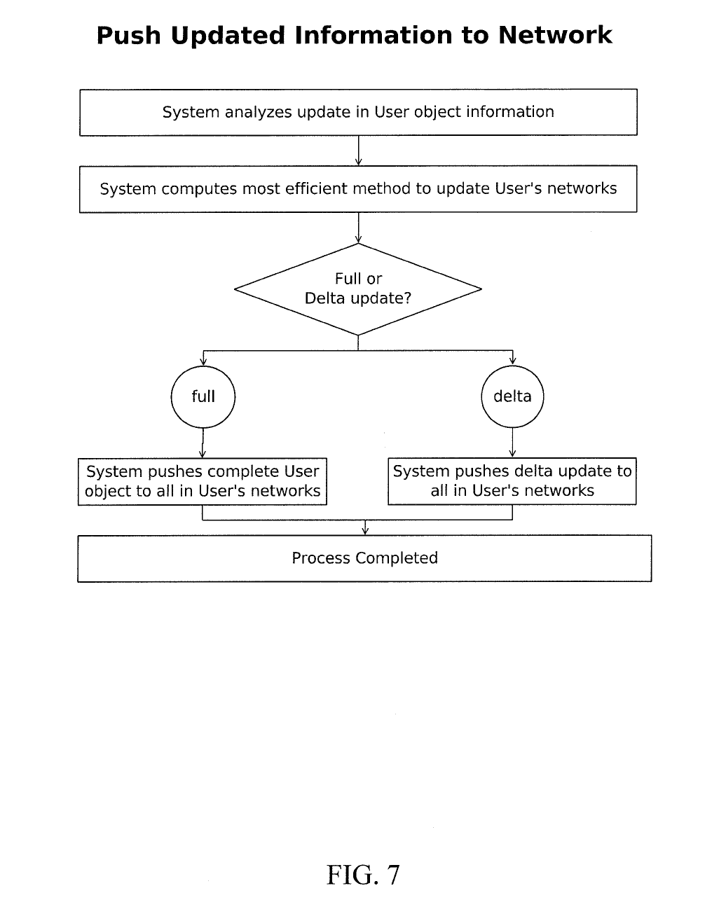

FIG. 7 depicts how the system of the invention updates a User object and automatically updates the updated information by “pushing” the updated information out to the network. Typically when there is a change to a User object (e.g., Persona edited, new Contact Handle, etc.), the System analyzes the update and computes the most efficient method to propagate the update to the User's networks. This comes in one of two forms. If the System determines that a full update is the most efficient method, then the System pushes the full User object to the User's networks. Alternatively, if the System determines that a partial (or “delta”) update is the most efficient method, the System pushes the delta information (i.e. the information that is different from the previous update) update to the User's networks. Ultimately, one of ordinary skill in the art will understand that the decision by the system on how to perform the update will be a tradeoff between the data transmission burden (transmitting a “full” update versus transmitting an update of just the “delta” or difference) and the computation time necessary to compute the difference or “delta”.

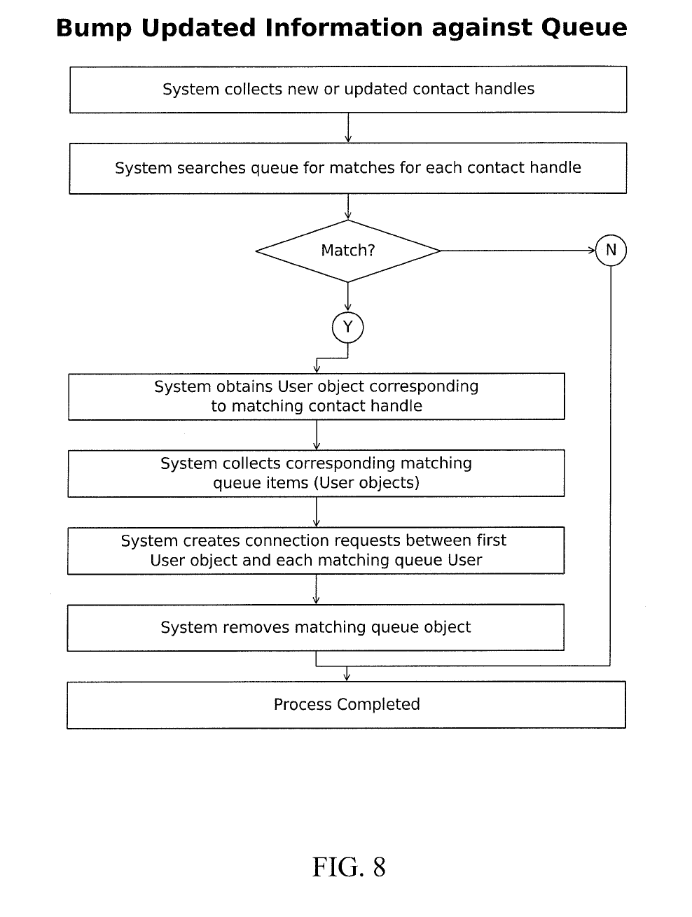

FIG. 8 depicts how the system can automatically both associate individuals that are currently within the system/network and already “connected” outside the system and can send requests to existing User contacts to join the individual's networks (i.e., how the System “bumps” updated information against the queue). The System collects new and/or updated Contact Handles. The System then searches the Queue for elements that match the new and/or updated contact handles. If one or more matches are found, then for each matching Queue item the system (a) collects the matching Queue item and obtains the corresponding User object; (b) converts the matching Queue item into a Connection Request between the corresponding User object and each of the Users referenced in the matching Queue item; and (c) removes the collected matching Queue items from the Queue.

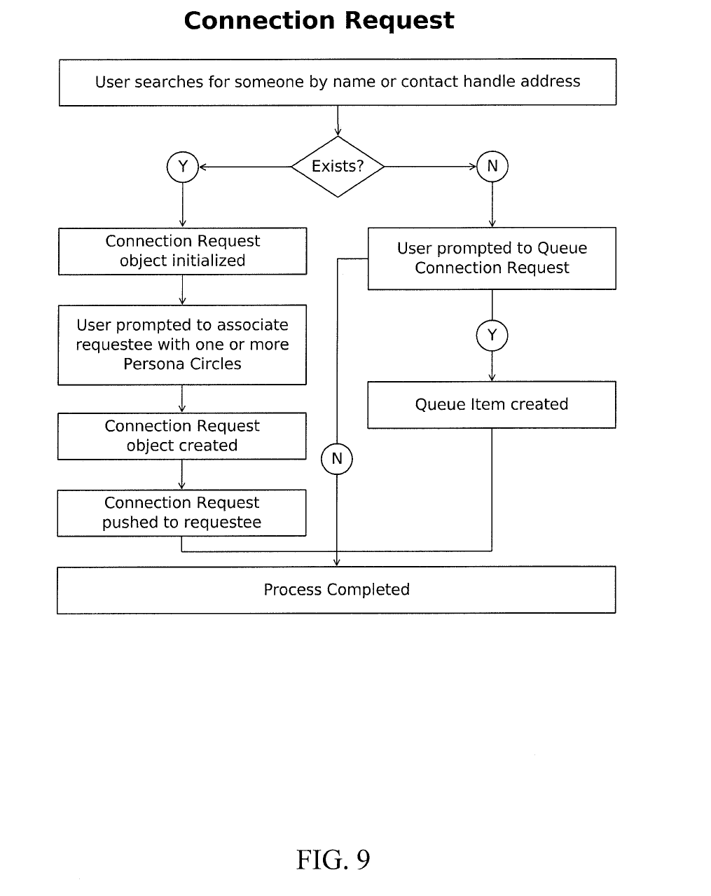

FIG. 9 depicts how a user of the system can invite someone to connect with them on the service. A User typically searches for a contact by a search string comprised of a name or contact handle(s). If the search string matches the information for one or more existing Users, the User is presented with the matching User(s). The User then selects the one from the list with whom s/he wishes to be connected. The User is then prompted to select the Personas that s/he wishes to associate the selected person with. The System then initializes a Connection Request object and populates the Connection Request object with requestor and requestee information. The contact request is then pushed to the requestee and the requestee receives a notification of the contact request.

If, alternatively the search string does not match information for an existing User, the User is asked whether s/he wishes that an automated Connection Request be created if/when the User they were searching for joins the system. If the User agrees, a Queue item is created. How this is done is described in more detail below.

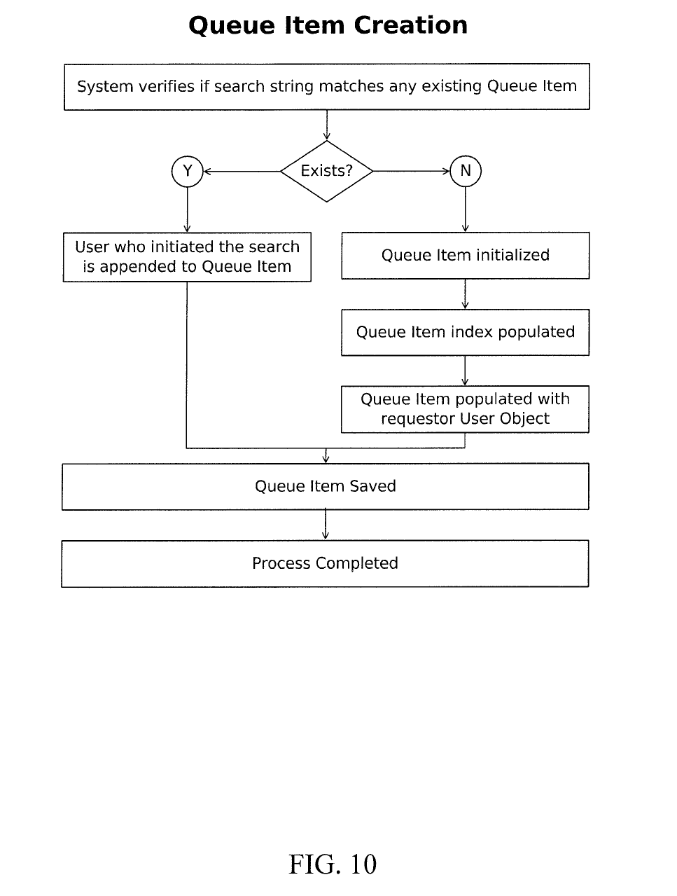

FIG. 10 depicts an exemplary method by which a current contact of an individual that may not currently be a user of the system may be queued for future invitation into an individual's network once the current contact becomes a user of the system, i.e., how the Queue item described above is created.

First, the System searches the Queue to see if a Queue item already exists with the search string. If a Queue item already exists then the User that entered the search string is appended to that Queue item. If a Queue item does not already exist then the System initializes a Queue object, the System then indexes the new Queue object with the search string and populates the new Queue object with the User that entered the search string.

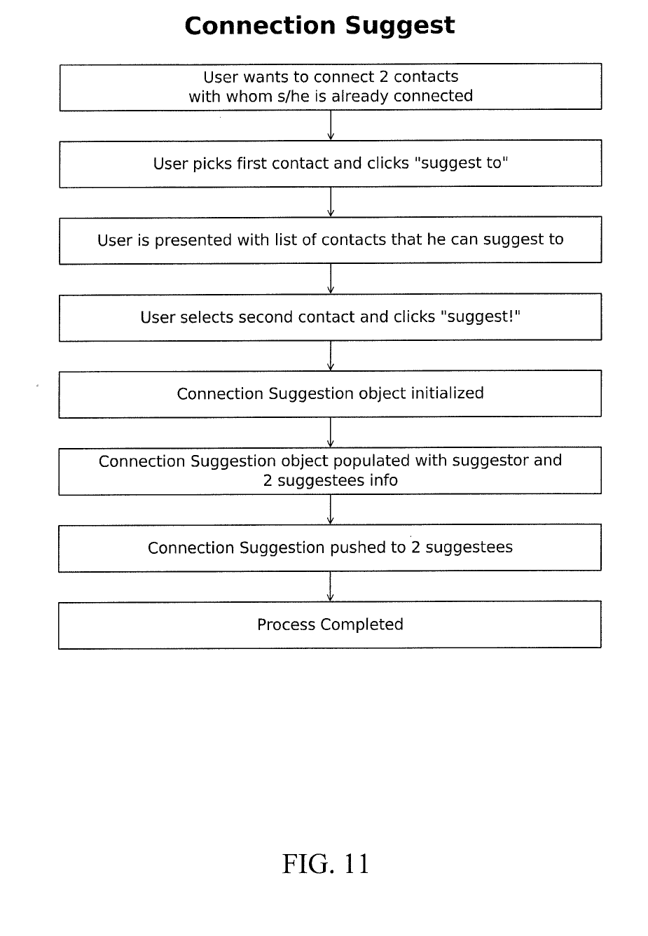

FIG. 11 depicts how the system may automatically suggest that two (or more) contacts of an individual user that are also current users of the system may become associated with each other and become contacts of each other. When a User wants to connect two (2) of his/her existing contacts together, the User selects the first of these contacts and would in one embodiment click the “suggest to” button. The System would then present the User with a list of all of his/her connection. The User then selects the second contact he wishes to connect to the first from the list and, in one embodiment, clicks “Suggest!” on the application. The System then initializes a Suggestion object and populates the Suggestion object with the suggestor's ID and the two contacts' User IDs that were selected. The System then pushes the Suggestion to the two contacts and notifies the two contacts of the new suggestion item.

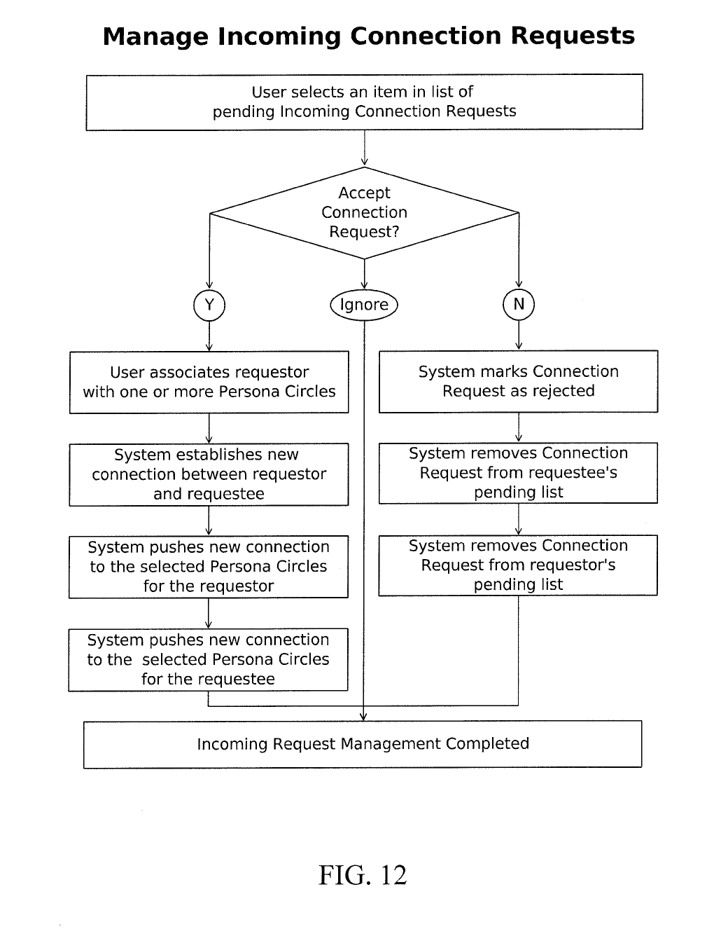

FIG. 12 depicts an exemplary method by which the system manages incoming Connection Requests for associating individuals that are already users of the system. The User would typically inspect the list of pending Connection Requests in order to determine which requests to accept and which requests to ignore. If the User accepts a particular Connection Request then the System prompts the User to select which of his/her Personas s/he wishes to associate the requestor with. The system then marks the request as accepted, converts the request to an active connection and pushes the new active connection to (a) the requestee's appropriate Persona's contact list; and (b) the requestor's appropriate Persona's contact list.

If, however, the User rejects the particular request the System marks the request as rejected and removes the rejected request from the Persona's list of pending requests.

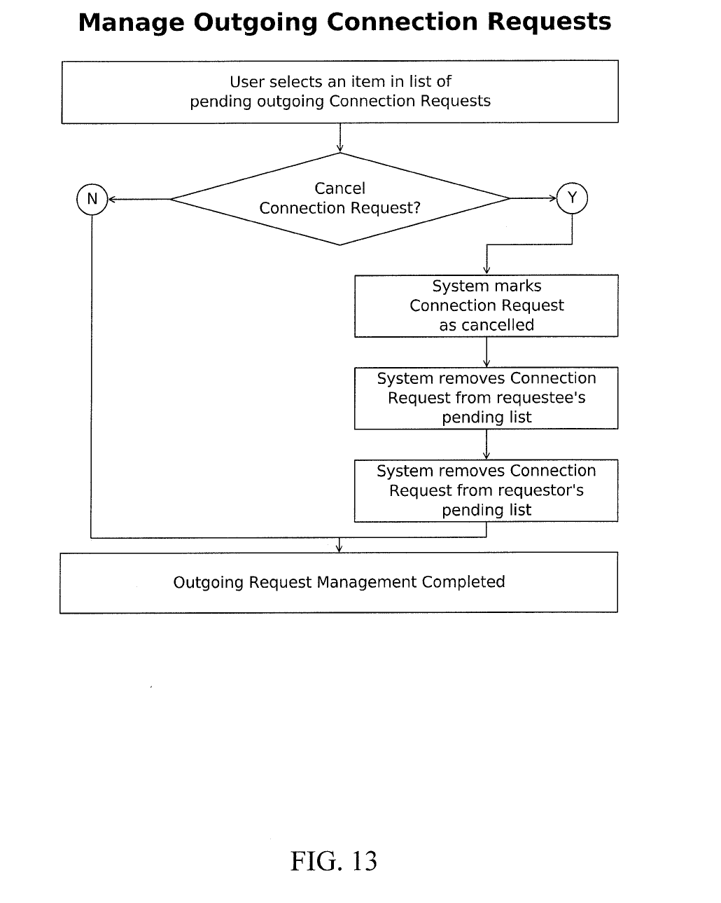

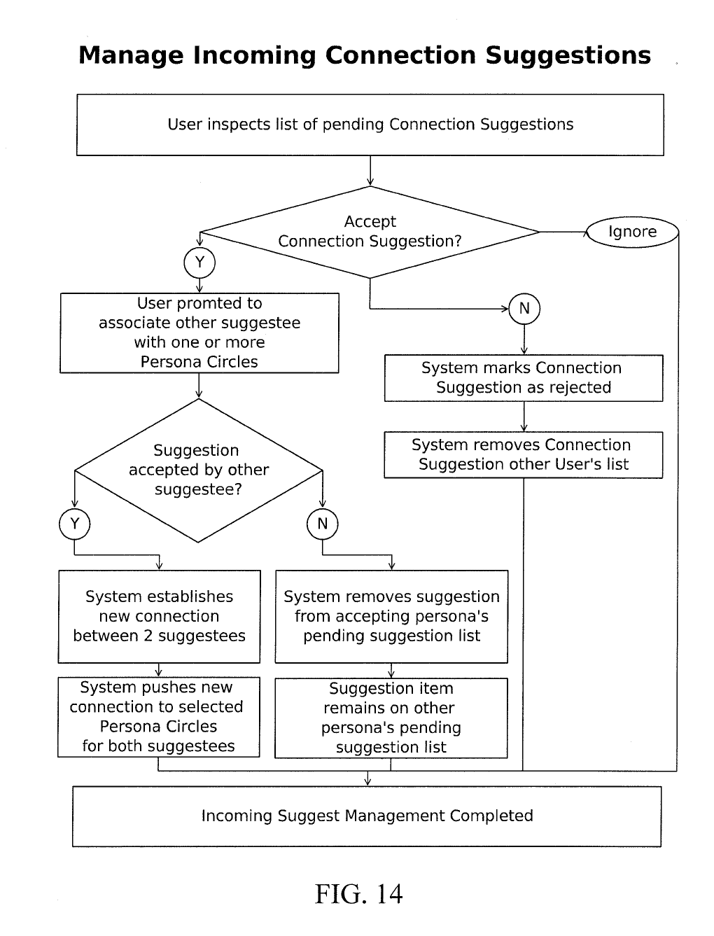

FIG. 13 depicts an exemplary method by which the system manages outgoing Connection Requests by an individual to have other users associated with one or more of the individual's Personas. The User typically inspects the list of pending outgoing Connection Requests. If the User chooses to cancel all outgoing requests then the System marks all outgoing requests as cancelled and removes the Connection Requests from both the list of pending outgoing Connection Requests and from the list of pending incoming Connection Requests for each requestee.

If, however, the User does not wish to cancel all, s/he goes through the list one-by-one and examines each request. If the User wishes to cancel a specific outgoing Connection Request the System marks the outgoing request as cancelled, removes the Connection Request from the list of pending outgoing Connection Requests and removes the contact request from the list of pending incoming contact requests for the requestee.

FIG. 14 depicts an exemplary method by which the system manages incoming Connection Suggestions. The User begins by inspecting the list of pending Connection Suggestions. To accept a Connection Suggestion, the User accepts the item in the list, the system then prompts the User to select the personas with which s/he wishes to associate this new Connection with. The System then marks the Connection Suggestion item as accepted on the accepting User's side. The System then removes the Connection Suggestion from the acceptor's list of pending Connection Suggestions. If the suggestion item is accepted on the other User's side, then the System pushes the new connection to the acceptor and to the other person in the suggestion item. If, however, the suggestion item is still pending on the other User's side, the suggestion item remains on the other User's list of pending suggestions.

To reject the Connection Suggestion, the System marks the suggestion item as rejected on the rejector's side, removes the suggestion item from the list of pending Connection Suggestions of the rejector's side and removes the Connection Suggestion item from the other User's list of pending suggestions.

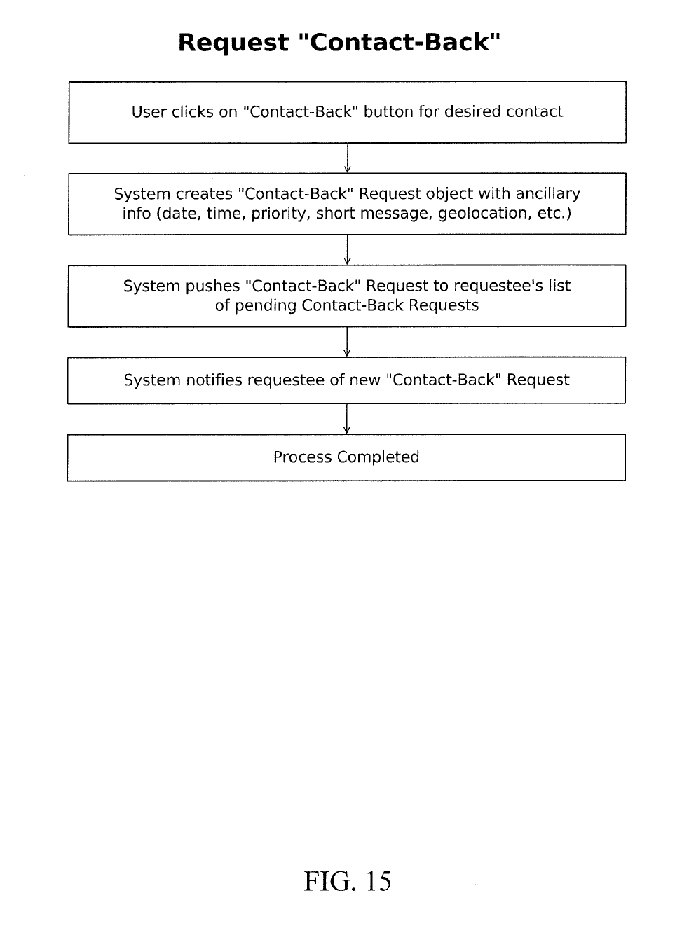

FIG. 15 depicts the optional “Contact-Back” Request feature of the system of the invention, whereby an individual may send a request to a user to be contacted back in a particular manner. To activate the “Contact-Back” feature, the User clicks on the “Contact-Back” button in the application for a desired contact. The System then creates a “Contact-Back” Request item and populates it with the requestor's ID, the requestee's ID, the date and time and other information as desired (short message, geolocation, etc.). The System then pushes the “Contact-Back” Request item to the requestee's list of pending “Contact-Backs” Requests and notifies the requestee of the new request.

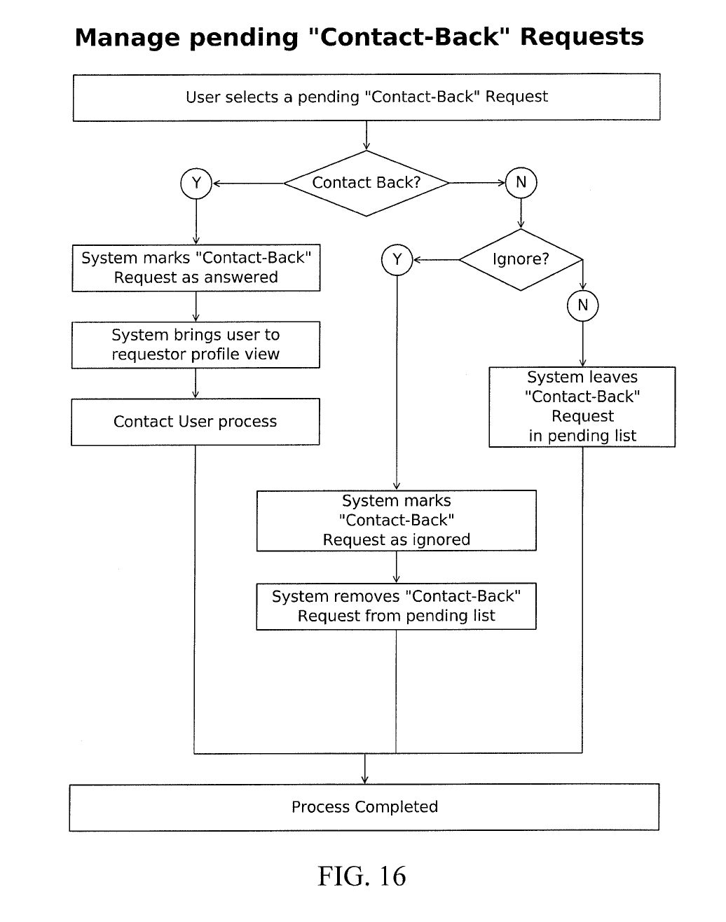

FIG. 16 depicts how the System manages “Contact-Back” Requests. The User inspects the list of pending “Contact-Back” Requests. If the User wishes to ignore all the “Contact-Back” Requests then the System marks all items as ignored and removes all ignored “Contact-Back” Requests from the list. If the User wishes to go through the list of pending “Contact-Back” Requests one-by-one then he determines whether s/he does or does not want to contact the person back.

If the User wishes to contact the person back then the User selects the “Contact-Back” Request item. The System then marks the selected item as answered and brings the User to the selected item's requestor's persona view and the User is taken through the Contact User process.

If the User does not wish to contact the person back there are two options. The User can either actively ignore the “Contact-Back” item or leave it in the pending list. If the User wishes to actively ignore a particular “Contact-Back” item, the User selects ignore for that item, the System then removes the ignored item from the list. If the User does not wish to actively ignore the request, the System leaves the “Contact-Back” Request item in the pending list.

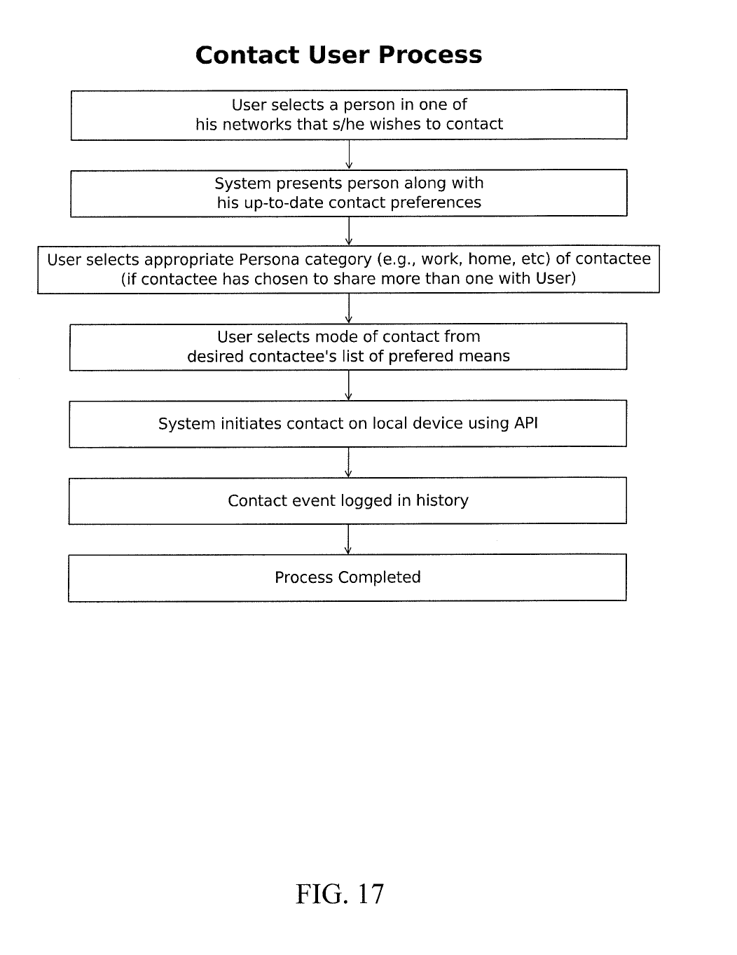

FIG. 17 depicts process by which a user of the system may contact an individual (also a user of the system) using the System. Typically, the User would select a contact in one of his/her Personas' networks. The System then presents the selected contact's persona along with the up-to-date associated contact preferences, according to that User's current Availability Status. If the contact has decided to associate the User with more than one of his/her Personas, the User can then select which Persona s/he wishes to contact. The User then selects the desired mode of contact from one of the options presented in the contact's Persona and the System initiates a communication event on the local device using the appropriate API and the communication event is logged.

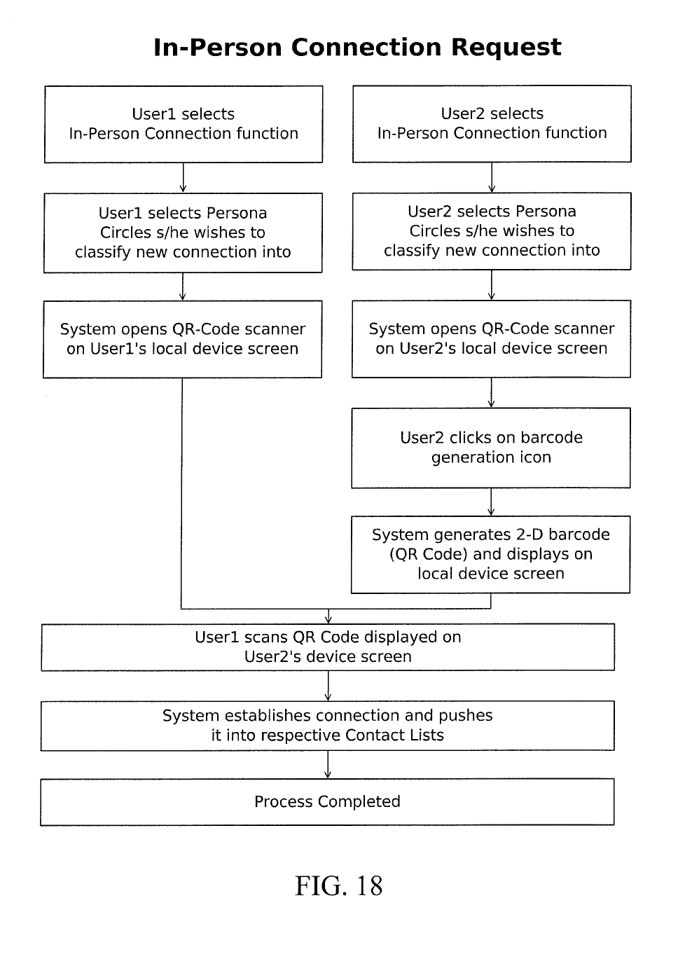

FIG. 18 depicts a method by which two users may become connected using the system. Specifically, this describes the process by which the System allows an individual to add someone to one's list of contacts when in-person. Typically, the first User clicks on the “Connect In-Person” button. The first User is then prompted to selects one or more of the User's Personas that s/he wishes to associate with the other person. In this embodiment, the System then opens a barcode scanning window. Meanwhile, the second User has also clicked the “Connect In-Person” button and subsequently selected the Personas s/he wished to associate with the first User. The second User then clicks on the “QR-Code” button presented on the scanning window. The System then presents the generated QR code on the screen of the second User's device. The first User then scans the QR code with his/her device. The System then creates an active connection between the two Users, and populates the connection item with the two Users' pre-selected Personas and pushes the connection item to both Users in their respective contact lists.

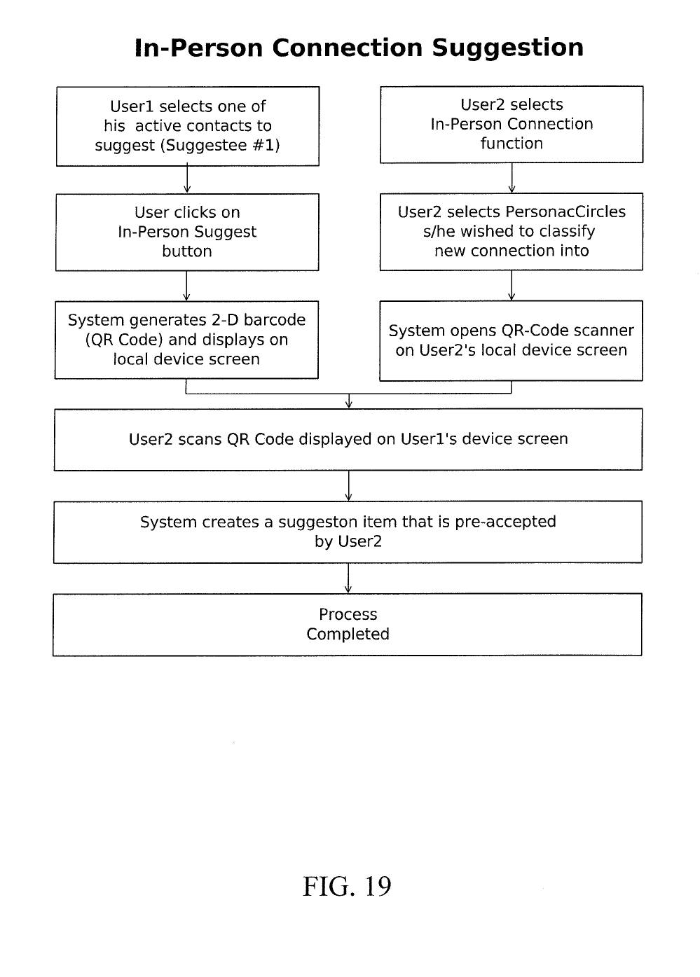

FIG. 19 depicts a method by which an individual can suggest that two users become rapidly connected (share personas) using the system. Specifically, this process describes how to suggest a contact to someone when in-person. Typically, the first User selects the contacts s/he wishes to suggest to the second User. The first User then clicks on the “Quick Suggest” button and the System then generates a 2-D QR code. The System then presents the generated QR code on the screen of the first User's device. The second User clicks on the “Connect In-Person” button, selects the Personas he wishes to associate with the suggested person. The System then opens a scanning window on the second User's device. The second User then scans the QR code on the first User's device with his/her device. The System then creates a suggestion item and populates the suggestion item with the scanner's selected Personas and the suggested contact's information. The System marks the suggestion as accepted on the scanner's side and pushes the suggestion item to the suggested contact.

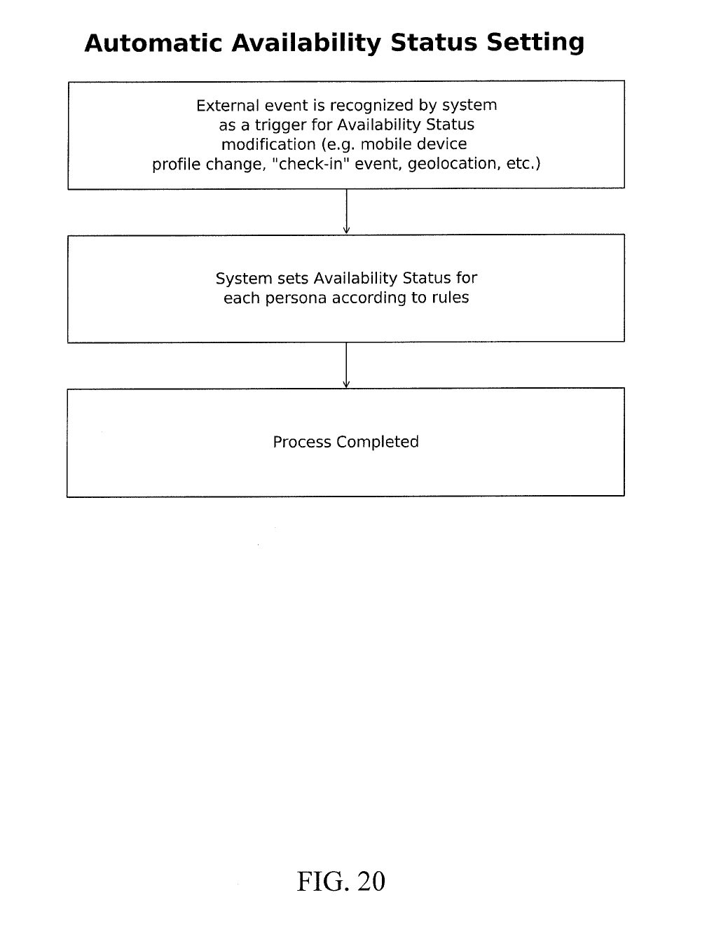

FIG. 20 depicts a method by which the system may automatically change or modify his/her current Availability Status. Here, an external event that was pre-defined by the User or the System is detected by the System as a triggering event to modify the User's current Availability Status (i.e. geolocation event, time-defined event, “check-in” event, mobile device persona change event, ping from external connected service, etc.). The System then sets the pre-defined Availability Status as his/her current status.

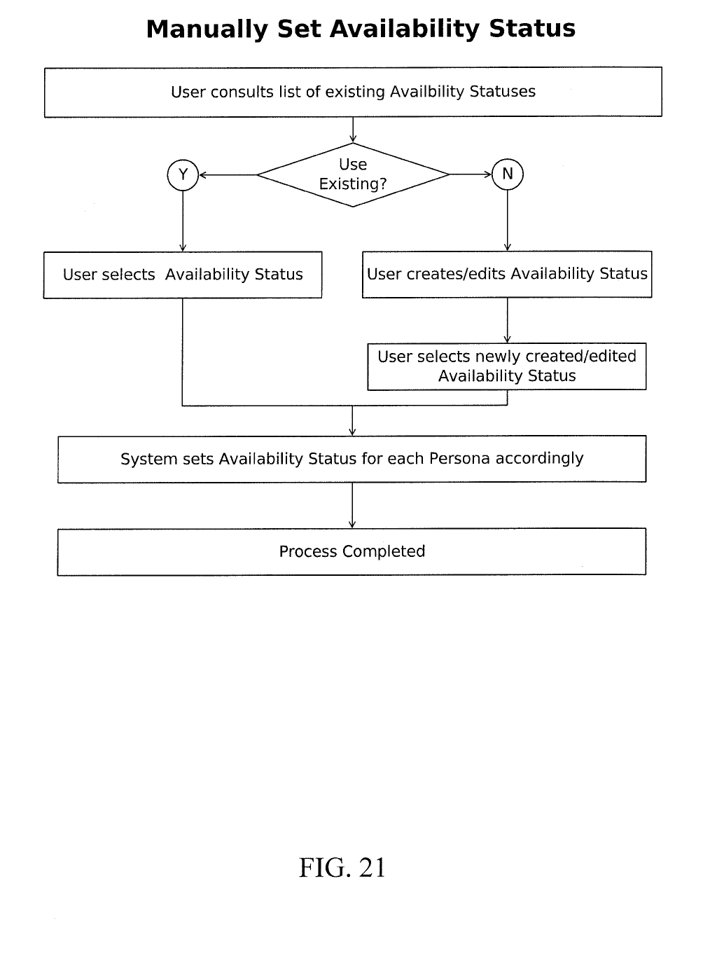

FIG. 21 depicts a method by which the User may manually change or modify his/her current Availability Status. Here, the User consults his/her list of pre-defined Availability Statuses. To set his/her current status as an existing Availability Status, the User simple selects the desired status. The User may also edit an existing Availability Status before or after having set it as the current status. The User may also create a new Availability Status and then set it as his/her current status.

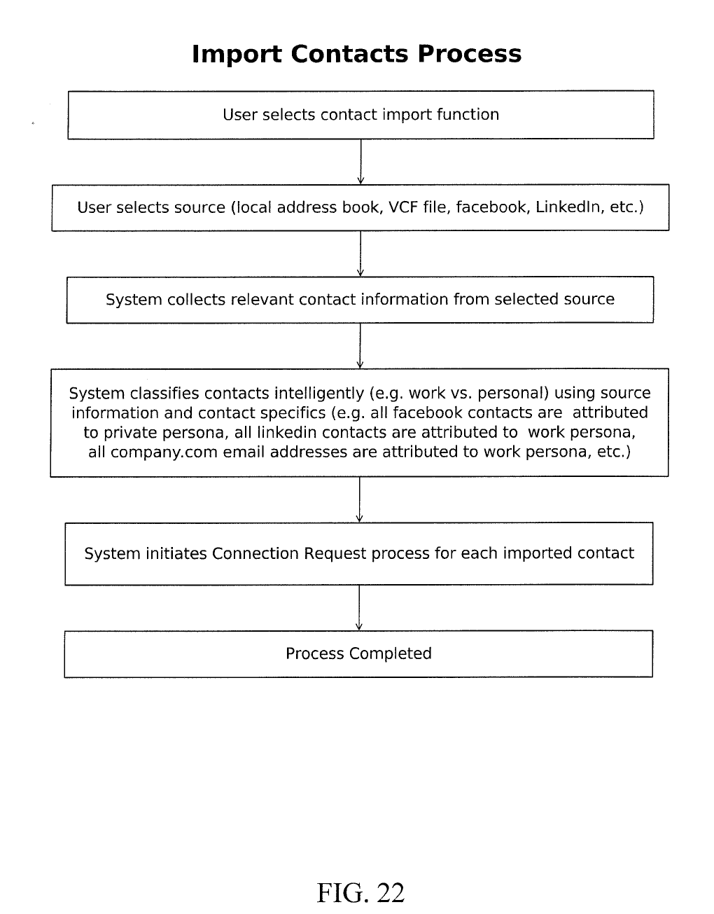

FIG. 22 depicts a method by which the System aids the user in importing contact information that is resident external to the System of the invention into the system. The system automatically categorizes and classifies the imported contact information. Initially, the User selects the contact import function. The User then selects the source of contact information s/he wishes to import (i.e. VCF file, local device's address book, Facebook contacts, Google contacts, LinkedIn contacts, Outlook contacts, etc.) The System collects the selected contact information using the appropriate API. The System then classifies the contacts according to pre-defined rules (e.g. all contacts that have email ending in gmail.com are associated with the User's Personal Persona, all contact information that have telephones with extensions are associated with the Persona's work Persona, all contacts that have emails with the same ending as the User's work Persona's email are associated with the User's work Persona, etc.). Finally, the System initiates the contact request process for each imported contact.

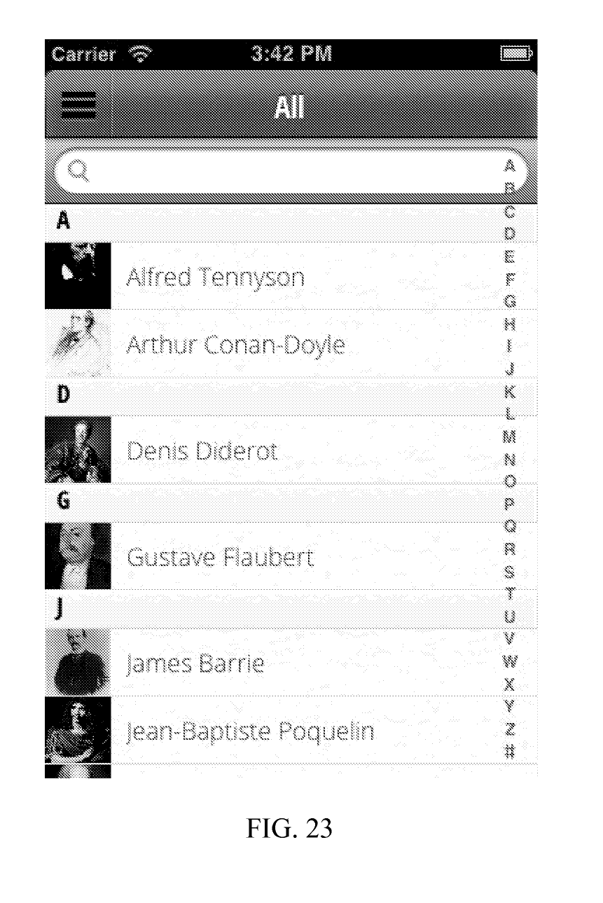

FIG. 23 is an exemplary embodiment of a VIEW ALL CONTACTS Screen. The top section is a display of information specific to a particular mobile device. The second section has a Navigation bar that includes a Menu button to return to main menu screen. The third section provides search bar for searching through the list of current contacts. The fourth section is comprised of an alphabetical list of contacts. For each contact, the contact's avatar is displayed, followed by the contact's name.

FIG. 24 is an exemplary embodiment of the VIEW CONTACTS ASSOCIATED WITH A SPECIFIC PERSONA Screen. The Top section includes a display of information specific to mobile device. The second section is comprised of a Navigation bar having a Menu button to return to main menu screen and a Persona button to view/edit the Persona's information. The third section provides search bar for searching through the list of current contacts. The fourth section is comprised of an alphabetical list of contacts associated with the selected persona. For each contact, the contact's avatar is displayed, followed by the contact's name.

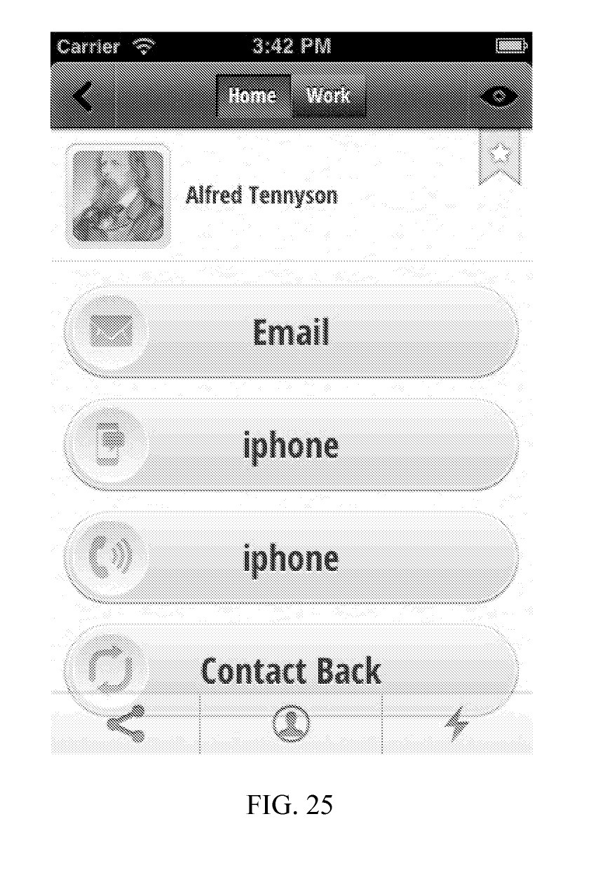

FIG. 25 is an exemplary embodiment of the VIEW OF SELECTED CONTACT Screen. The top section is a display of information specific to mobile device. The second section comprises a Navigation bar that includes a Back button to return to the list of contacts; a tab bar containing the list of Personas that the contact has opted to share with the User; and a View button that reveals the selected persona's preferred contact information in detail. The third section consists of the Contact's avatar, name, a button to add that contact to the User's list of favorite contacts. The fourth section includes a rank ordered list of methods that the contact has set as his/her preferred means of communication (i.e. in this case, send email to his “Email”, send a text message to his “iPhone”, then call his “iPhone”). In this representation there is an optional “Contact-back” button that can engage the “contact-back” feature described above. In addition, this section includes a button to move or copy this contact to another persona and a button that enables the user to suggest this contact to another persona in user's network. The fifth section is a toolbar, which includes a “Suggest” button enabling the user share this contact with another one of his/her contacts (see FIG. 11), an “Associate” button enabling the user to associate this contact with one or more of his/her personas, and a “Disconnect” button enabling the user to disconnect from the contact.

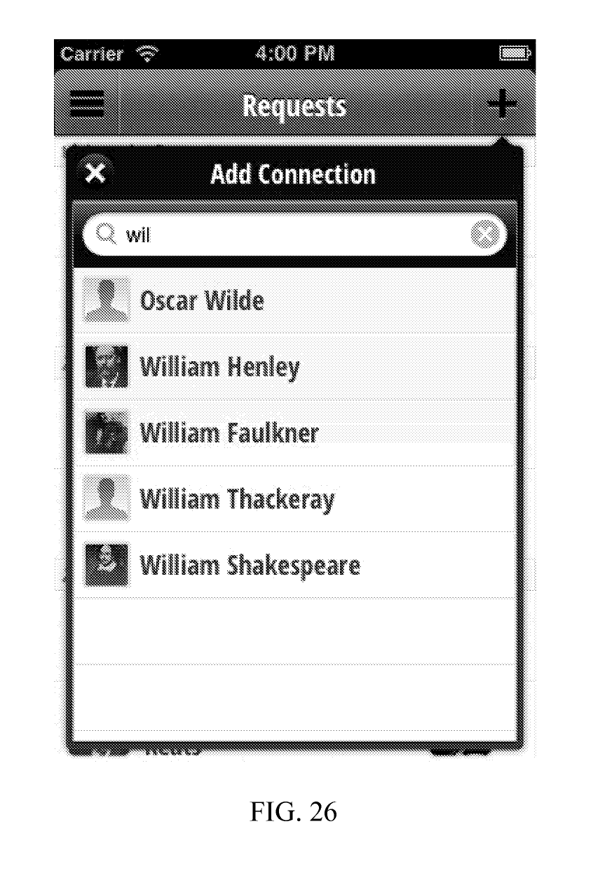

FIG. 26 is an exemplary embedment of the ADD CONNECTION Screen. The top section is a display of information specific to mobile device. The second section is a Navigation bar that includes a “menu” button enabling the User to return to the main menu screen; and an Add Connection button that brings the User to the Add Connection screen (THIS FIGURE). The third section is a Search bar that enables the User to search through all users on the service. The fifth section is a “results” section where the list of results matching the search string is displayed. For each result, the user's avatar is displayed, followed by the user's name. Clicking on a row will initiate the process to invite that user to become an active connection on the network (see FIG. 8).

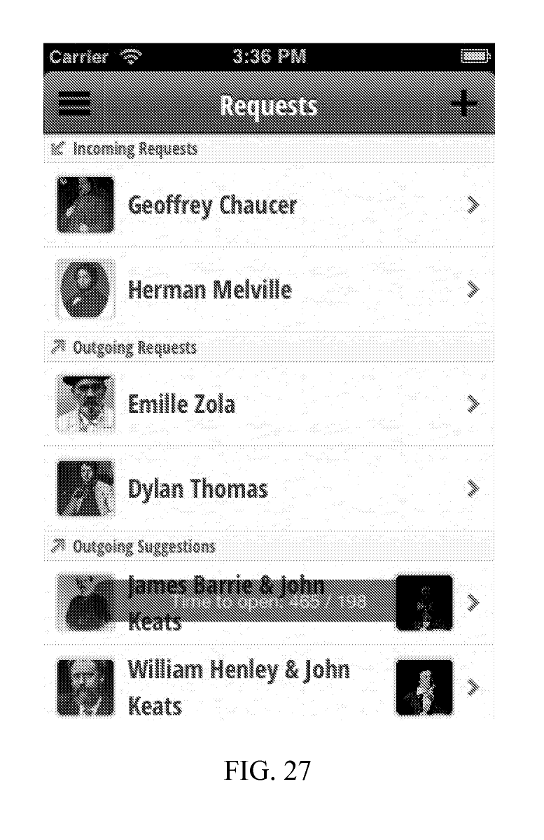

FIG. 27 is an exemplary embodiment of a PENDING CONNECTIONS SCREEN. The top section is a display of information specific to mobile device. The second section is a Navigation bar including a Menu button to return to main menu screen; and an Add Connection button that brings the User to the Add Connection (FIG. 26). The third section comprises a list of the pending Connection requests. It provides a list of all incoming and outgoing connection requests, as well as incoming and outgoing connection suggestions. For each request and suggestions, the concerned user's avatar(s) are displayed, along with the user's name(s). The User can act on each request or suggestion by clicking on the appropriate row (to accept, reject, cancel or ignore the request/suggestion—see FIGS. 12, 13 &14).

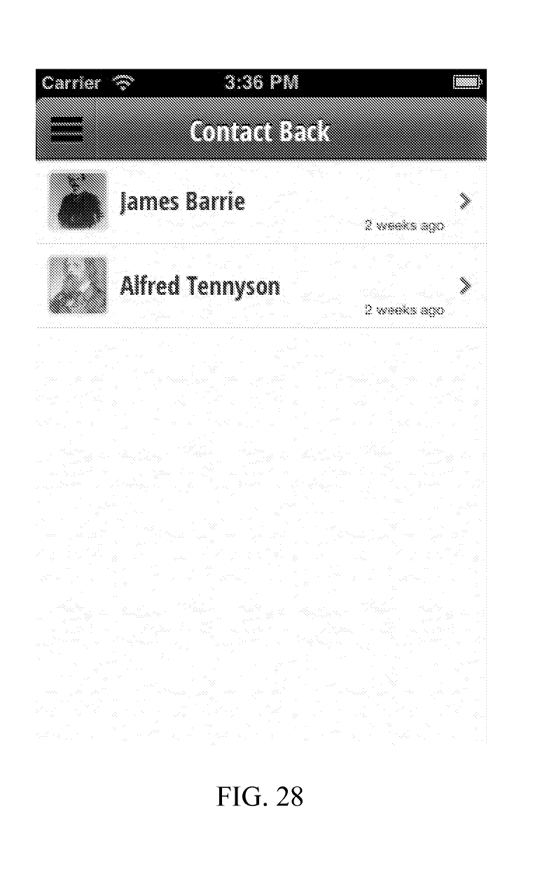

FIG. 28 is an exemplary embodiment of a PENDING CONTACT-BACK REQUESTS SCREEN. The top section is a display of information specific to mobile device. The second section is a Navigation bar including a Menu button to return to main menu screen. The third section comprises a list of the pending the Contact-back requests. It provides a list of all requests to be contacted back. For each request, the requesting persona's avatar is displayed, along with the requesting User's name, and the date and time that the request was submitted. Clicking on each row will enable the User to act on the selected Contact-Back request (see FIG. 16)

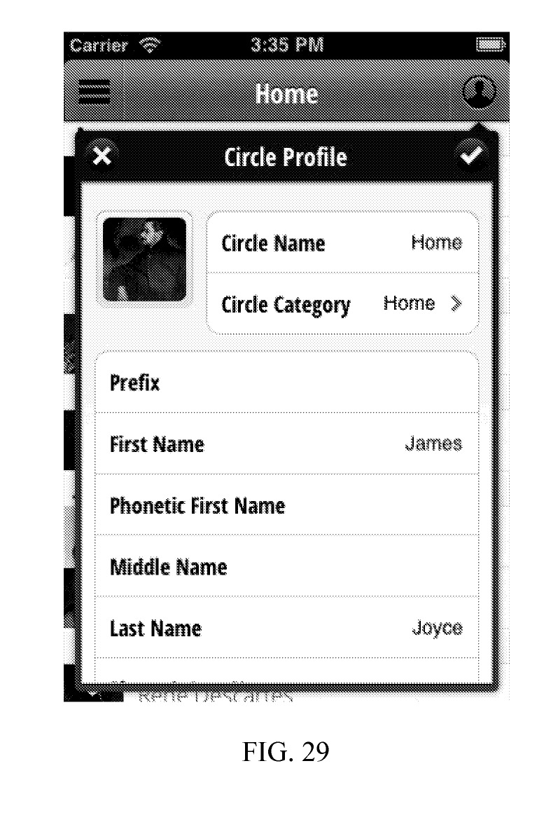

FIG. 29 is an exemplary embodiment of an EDIT OWN PERSONA Screen. The top section is a display of information specific to the mobile device. The second section is a Navigation bar that provides a Menu button for returning to the main menu screen; and a Persona button for viewing/editing the Persona details (THIS FIGURE). The third section is a View of the persona selected. The view includes the Persona's avatar, name, and information.

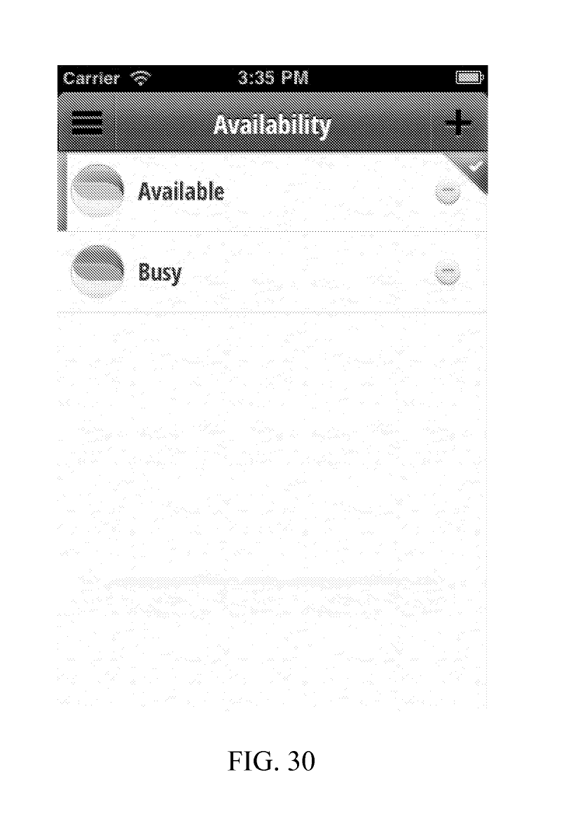

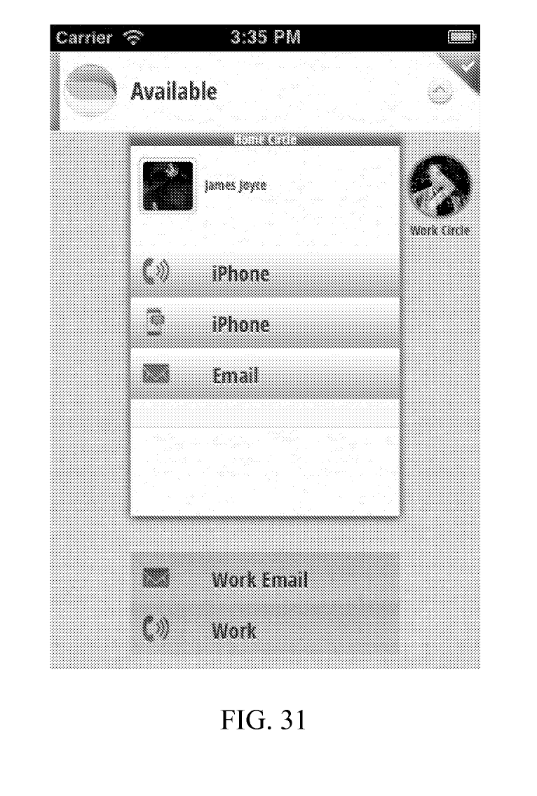

FIG. 30 is an exemplary embodiment of an AVAILABILITY STATUS SELECTION screen. The top section is a display of information specific to the mobile device. The second section is a Navigation bar that provides a Menu button for returning to the main menu screen; and an ADD NEW AVAILABILITY STATUS button for creating a new availability status. The third section is a list of all preset availability statuses, along with an indication of which availability status is currently set. Each row is comprised of an image specific to each availability status and a name for the availability status. A button to reveal/edit the availability status is set on the right side of each row (see FIG. 31). The currently set availability status is signified by a presence checkmark in the upper right corner of the row.

FIG. 31 is an exemplary embodiment of an AVAILABILITY STATUS EDIT screen. The top section is a display of information specific to the availability status being edited and contains a button on the right side to save changes to return to the list of Availability Statuses (FIG. 30). The second section shows a view of the way that people associated with each person will view them (a miniaturized view of FIG. 25); it contains the persona information as well as the ranked list of active contact handles for the specific availability status. It also shows the contact handles that are inactive. The user can click and drag contact handles around to arrange the contact handles in his/her preferred order for that availability status and for that persona. The user can also see the list of active contact handles for other persona by clicking on the button of to top right of section 3.

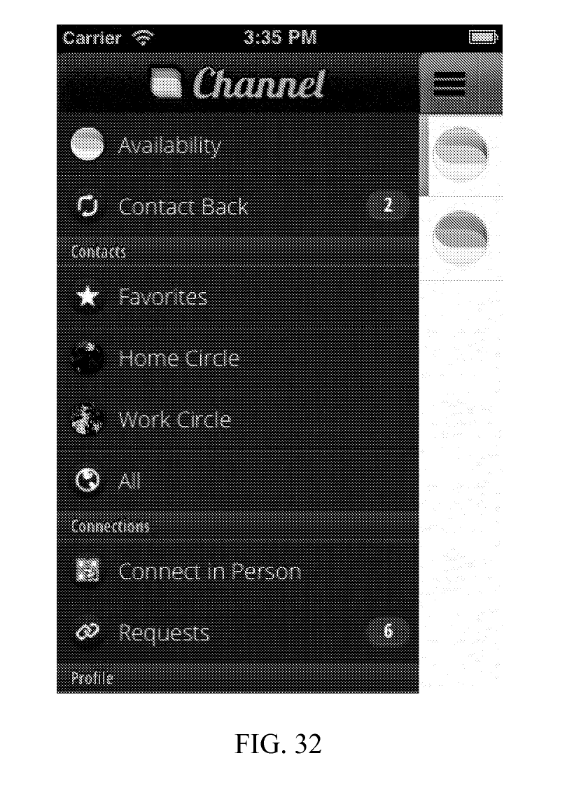

FIG. 32 is an exemplary embodiment of the MAIN MENU screen. The top section is a display of information specific to the mobile device. The second section is a Logo bar. The third section is a list of all the available menu options. The user can select to set his current availability (FIG. 30), see pending contact-back requests (FIG. 28), consult the list of his/her favorite contacts, consult the list of contacts for each one of his personas (FIG. 24), consult the list of all his/her contact (FIG. 23), Connect with someone in-person (FIG. 19), consult the list of pending requests (FIG. 27), manage his/her contact handles (not shown), and change the application settings (not shown).

1. A method of managing contact information for a user, comprising:
(a) creating with a digital data processor one or more personas in response to receiving personal information from the user;
(b) creating with a digital data processor one or more contact handles associated with the user, wherein each contact handle comprises an identifying name, one or more communication protocols, and a value;
(c) creating with a digital data processor one or more availability statuses, wherein each availability status comprises, for each of the one or more personas of the user, a persona-specific listing of selected contact handles and communication methods that may be used to reach the user, wherein each communication method is associated with a communication protocol of a contact handle;
(d) storing the one or more personas, the one or more contact handles, and the one or more availability statuses in a data store accessible to the digital data processor;
(e) determining a current availability status from the one or more availability statuses; and
(f) communicating to one or more other users the persona-specific listing of selected contact handles and communication methods associated with the current availability status for each of the one or more personas of the user that the one or more other users have been granted access to.

2. The method of claim 1, wherein the selected contact handles and communication methods in the persona-specific listing associated with an availability status are ranked by the user.

3. The method of claim 1, wherein the user's current availability status is communicated automatically to the one or more other users.

4. The method of claim 1, wherein the user's current availability status is determined based on a selection received from the user.

5. The method of claim 1, wherein the user's current availability status is determined based on a received physical or temporal location of the user.

6. The method of claim 1, wherein the user's current availability status is determined based on a state of a device associated with the user.

7. The method of claim 1, wherein each of the one or more contact handles is selected from the group consisting of landline phone number, mobile phone number, email address, chat address, social networking page, web address, postal address, or other physical or electronic address.

8. The method of claim 1, wherein the communication method is selected from the group consisting of making a voice call, sending an email, sending a text message, posting to a website, launching a chat session, posting to a microblog, or sending a message through a proprietary or 3^{rd} party social network.

9. The method of claim 1, wherein communicating to the one or more other users the persona-specific listing of selected contact handles and communication methods associated with the current availability status comprises communicating between the data store and a plurality of remote devices.

10. The method of claim 9, wherein the plurality of remote devices comprises any of a personal computer and a mobile computing device.

11. The method of claim 10, wherein the mobile computing device is selected from the group consisting of a mobile phone and a tablet computer.

12. The method of claim 8, wherein the communication method is performed by accessing a software application resident on a remote device.

13. The method of claim 12, wherein the remote device accesses the data store, determines a preferred contact handle and communication method for the user, and proceeds to contact the user via the preferred contact handle and communication method.

14. The method of claim 1, further comprising receiving a request for contact from one or more of the other users and notifying the user of the request for contact.

15. A system for managing contact information for a plurality of users, comprising:
(a) a first digital data processor coupled to a data store and configured to store for each of the plurality of users:
(i) one or more personas created by the user, wherein each persona includes personal information provided by the user,
(ii) one or more contact handles in association with user, wherein each contact handle comprises an identifying name, one or more communication protocols, and a value,
(iii) one or more availability statuses created by the user, wherein each availability status comprises, for each of the one or more personas of the user, a persona-specific listing of selected contact handles and communication methods that may be used to reach the user, wherein each communication method is associated with a communication protocol of a contact handle, and
(iv) one or more contacts associated with the user, each contact being another user on the system for which the user has granted access to one or more personas; and
(b) a remote device comprising a second digital data processor that is configured to generate a look-up request for transmission to the first digital data processor in response to input from a first user and display to the first user results received from the first digital data processor in response to said request;
wherein the first digital data processor is further configured to receive the look-up request from the remote device, access the data store to obtain the persona-specific listing of selected contact handles and communication methods associated with a current availability status of a second user, the listing being specific to a relationship between the first user and the second user that matches the look-up request, and transmit the listing to the second digital data processor.

16. The system of claim 15, wherein the second digital data processor is further configured to compare the communication methods received from the first digital data processor with communication methods stored in association with the first user and prioritize the communication methods common to both the first and the second user.

17. The system of claim 15, wherein the second digital data processor is further configured to initiate contact between the first user and the second user via the contact handles and communication methods of the second user's persona-specific listing.

18. The system of claim 15, wherein the personal information provided by the user includes any of a name, a picture, a job title, a slogan, and a nickname.

19. The system of claim 15, wherein the second digital data processor is further configured to create sub-lists of the one or more contacts associated with the user based on one the current availability statuses of the one or more contacts and the communication methods associated therewith.

20. The system of claim 15, wherein the second digital data processor is further configured to transmit to the first digital data processor a request for contact from the second user.
